(19) United States
(12) Patent Application Publication
(10) Pub. No.: US 2026/0094859 A1
(43) Pub. Date: Apr. 2, 2026

(54) SECONDARY BATTERY AND BATTERY PACK

(71) Applicant: MURATA MANUFACTURING CO., LTD., Kyoto (JP)

(72) Inventors: Hironobu KOBAYASHI, Kyoto (JP); Hiroki TAKADA, Kyoto (JP)

(21) Appl. No.: 19/297,443

(22) Filed: Aug. 12, 2025

(30) Foreign Application Priority Data
Sep. 30, 2024 (JP) 2024-171278

(51) Int. Cl. H01M 10/04

(52) U.S. Cl. CPC H01M 10/0431

(57) ABSTRACT

In a secondary battery, a first end face of an electrode wound body and a first electrode current collector plate are joined to each other by one or more first joint parts. The one or more first joint parts each have a meander shape in a plan view. The meander shape includes multiple first linear parts and multiple first turning parts. In each of the one or more first joint parts, a length in a winding direction of the electrode wound body from an a-th one to an (a+1)th one of the first turning parts counted from a winding center of the electrode wound body is longer than a length in the winding direction from a first one to a second one of the first turning parts, of corresponding one of the first joint parts, counted from the winding center.

### CROSS-REFERENCE TO RELATED APPLICATIONS

The present application claims priority from Japanese Patent Application No. 2024-171278 filed on Sep. 30, 2024, the entire contents of which are hereby incorporated by reference.

### BACKGROUND

The present disclosure relates to a secondary battery, and to a battery pack that includes the secondary battery.

Various kinds of electronic equipment, including mobile phones, have been widely used. Such widespread use has promoted development of a secondary battery as a power source that is smaller in size and lighter in weight and allows for a higher energy density. The secondary battery includes a battery device contained inside an outer package member. A configuration of the secondary battery has been considered in various ways.

For example, a secondary battery is proposed in which what is called a tabless structure is employed. Such a secondary battery achieves a reduced internal resistance and allows for charging and discharging with a relatively large current.

### SUMMARY

A secondary battery according to an embodiment of the present disclosure includes an electrode wound body, a first electrode current collector plate, and a second electrode current collector plate. The electrode wound body includes a stacked body and has a through hole. The stacked body includes a first electrode, a second electrode, and a separator, and is wound along a longitudinal direction of the stacked body. The through hole extends through the electrode wound body in a width direction orthogonal to the longitudinal direction. The first electrode current collector plate and the second electrode current collector plate are opposed to each other with the electrode wound body interposed between the first electrode current collector plate and the second electrode current collector plate in the width direction. The electrode wound body includes a first end face and a second end face. The first end face faces the first electrode current collector plate in the width direction. The second end face faces the second electrode current collector plate in the width direction. The first electrode current collector plate and the first end face are joined to each other by one or more first joint parts. The one or more first joint parts each have a meander shape in a plan view in a plane orthogonal to the through hole. The meander shape includes multiple first linear parts and multiple first turning parts. The first linear parts are adjacent to each other in a radial direction of the electrode wound body. The first turning parts couple the first linear parts to each other. In each of the one or more first joint parts, a length in a winding direction of the electrode wound body from an a-th one of the first turning parts counted from a winding center of the electrode wound body to an (a+1)th one of the first turning parts counted from the winding center is longer than a length in the winding direction from a first one of the first turning parts, of corresponding one of the first joint parts, counted from the winding center to a second one of the first turning parts, of the corresponding one of the first joint parts, counted from the winding center, where a number of the first turning parts is represented by “n”, “n” is a natural number, and “a” is a natural number greater than or equal to two and less than “n”.

A battery pack according to an embodiment of the present disclosure includes a secondary battery, a controller, and an outer package body. The processor is configured to control the secondary battery. The outer package body contains the secondary battery. The secondary battery includes an electrode wound body, a first electrode current collector plate, and a second electrode current collector plate. The electrode wound body includes a stacked body and has a through hole. The stacked body includes a first electrode, a second electrode, and a separator, and is wound along a longitudinal direction of the stacked body. The through hole extends through the electrode wound body in a width direction orthogonal to the longitudinal direction. The first electrode current collector plate and the second electrode current collector plate are opposed to each other with the electrode wound body interposed between the first electrode current collector plate and the second electrode current collector plate in the width direction. The electrode wound body includes a first end face and a second end face. The first end face faces the first electrode current collector plate in the width direction. The second end face faces the second electrode current collector plate in the width direction. The first electrode current collector plate and the first end face are joined to each other by one or more first joint parts. The one or more first joint parts each have a meander shape in a plan view in a plane orthogonal to the through hole. The meander shape includes multiple first linear parts and multiple first turning parts. The first linear parts are adjacent to each other in a radial direction of the electrode wound body. The first turning parts couple the first linear parts to each other. In each of the one or more first joint parts, a length in a winding direction of the electrode wound body from an a-th one of the first turning parts counted from a winding center of the electrode wound body to an (a+1)th one of the first turning parts counted from the winding center is longer than a length in the winding direction from a first one of the first turning parts, of corresponding one of the first joint parts, counted from the winding center to a second one of the first turning parts, of the corresponding one of the first joint parts, counted from the winding center, where a number of the first turning parts is represented by “n”, “n” is a natural number, and “a” is a natural number greater than or equal to two and less than “n”.

### BRIEF DESCRIPTION OF THE FIGURES

The accompanying drawings are included to provide a further understanding of the present disclosure and are incorporated in and constitute a part of this specification. The drawings illustrate example embodiments and, together with the specification, serve to explain the principles of the present disclosure.

FIG. 1 is a sectional diagram illustrating a configuration example of a vertical sectional structure, along a height direction, of a secondary battery according to one example embodiment of the present disclosure.

FIG. 2 is a schematic diagram illustrating a configuration example of a stacked body including a positive electrode, a negative electrode, and a separator illustrated in FIG. 1.

FIG. 3 is a sectional diagram illustrating a configuration example of a horizontal sectional structure of an electrode wound body illustrated in FIG. 1.

FIG. 4A is a developed view of the positive electrode illustrated in FIG. 1.

FIG. 4B is a sectional view of the positive electrode illustrated in FIG. 1.

FIG. 5A is a developed view of the negative electrode illustrated in FIG. 1.

FIG. 5B is a sectional view of the negative electrode illustrated in FIG. 1.

FIG. 6A is a plan diagram illustrating an upper end face of the electrode wound body illustrated in FIG. 1.

FIG. 6B is a plan diagram illustrating a lower end face of the electrode wound body illustrated in FIG. 1.

FIG. 7A is a plan view of a positive electrode current collector plate illustrated in FIG. 1.

FIG. 7B is a plan view of a negative electrode current collector plate illustrated in FIG. 1.

FIG. 8A is a plan diagram illustrating a configuration example of a first joint part between the upper end face of the electrode wound body and the positive electrode current collector plate illustrated in FIG. 1.

FIG. 8B is a plan diagram illustrating a configuration example of a second joint part between the lower end face of the electrode wound body and the negative electrode current collector plate illustrated in FIG. 1.

FIG. 9A is an enlarged schematic plan view of the first joint part illustrated in FIG. 8A.

FIG. 9B is a sectional diagram illustrating a section of the first joint part illustrated in FIG. 8A and the vicinity thereof.

FIG. 10A is an enlarged schematic plan view of the second joint part illustrated in FIG. 8B.

FIG. 10B is a sectional diagram illustrating a section of the second joint part illustrated in FIG. 8B and the vicinity thereof.

FIGS. 11A to 11F are each a perspective diagram describing a process of manufacturing the secondary battery illustrated in FIG. 1.

FIG. 12 is a block diagram illustrating a circuit configuration of a battery pack to which the secondary battery according to one example embodiment of the present disclosure is applied.

FIG. 13A is a plan diagram illustrating a configuration example of a first joint part between an upper end face of an electrode wound body and a positive electrode current collector plate in a secondary battery according to a first modification example of one example embodiment of the present disclosure.

FIG. 13B is an enlarged schematic plan view of the first joint part of the first modification example illustrated in FIG. 13A.

FIG. 14A is a plan diagram illustrating a configuration example of a first joint part between an upper end face of an electrode wound body and a positive electrode current collector plate in a secondary battery according to a second modification example of one example embodiment of the present disclosure.

FIG. 14B is an enlarged schematic plan view of the first joint part of the second modification example illustrated in FIG. 14A.

FIG. 15A is a plan diagram illustrating a configuration example of a first joint part between an upper end face of an electrode wound body and a positive electrode current collector plate in a secondary battery according to a first example of a third modification example of one example embodiment of the present disclosure.

FIG. 15B is a plan diagram illustrating a configuration example of a first joint part between an upper end face of an electrode wound body and a positive electrode current collector plate in a secondary battery according to a second example of the third modification example of one example embodiment of the present disclosure.

FIG. 16 is a plan diagram illustrating a configuration example of a first joint part between an upper end face of an electrode wound body and a positive electrode current collector plate in a secondary battery according to a fourth modification example of one example embodiment of the present disclosure.

FIG. 17 is a plan diagram illustrating a configuration example of a first joint part between an upper end face of an electrode wound body and a positive electrode current collector plate in a secondary battery according to a fifth modification example of one example embodiment of the present disclosure.

FIG. 18 is a plan diagram illustrating a configuration example of a first joint part between an upper end face of an electrode wound body and a positive electrode current collector plate in a secondary battery according to a sixth modification example of one example embodiment of the present disclosure.

FIG. 19 is a plan diagram illustrating a configuration example of a first joint part between an upper end face of an electrode wound body and a positive electrode current collector plate in a secondary battery according to a seventh modification example of one example embodiment of the present disclosure.

FIG. 20 is a plan diagram illustrating a configuration example of a first joint part between an upper end face of an electrode wound body and a positive electrode current collector plate in a secondary battery according to an eighth modification example of one example embodiment of the present disclosure.

FIG. 21 is a plan diagram illustrating a configuration example of a first joint part between an upper end face of an electrode wound body and a positive electrode current collector plate in a secondary battery according to a ninth modification example of one example embodiment of the present disclosure.

FIG. 22 is a plan diagram illustrating a configuration example of a first joint part between an upper end face of an electrode wound body and a positive electrode current collector plate in a secondary battery according to a tenth modification example of one example embodiment of the present disclosure.

FIG. 23 is a plan diagram illustrating a first joint part between an upper end face of an electrode wound body and a positive electrode current collector plate in a secondary battery as a first comparative example.

FIG. 24A is a plan diagram illustrating a first joint part between an upper end face of an electrode wound body and a positive electrode current collector plate in a secondary battery as a second comparative example.

FIG. 24B is an enlarged schematic plan view of the first joint part illustrated in FIG. 24A.

### DETAILED DESCRIPTION

Consideration has been given in various ways to improve performance of a secondary battery. There is, however, still room for improvement in terms of the performance of the secondary battery.

It is desirable to provide a secondary battery having superior performance, and to provide a battery pack that includes such a secondary battery.

In the following, the present disclosure is described in further detail including with reference to the accompanying drawings according to an embodiment. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following example embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

First, a description is given of a secondary battery according to an example embodiment of the present disclosure.

In the present example embodiment, a cylindrical lithium-ion secondary battery having an outer appearance of a cylindrical shape will be described as an example. However, a secondary battery of an embodiment of the present disclosure is not limited to the cylindrical lithium-ion secondary battery, and may be a lithium-ion secondary battery having an outer appearance of a shape other than the cylindrical shape, or may be a secondary battery in which an electrode reactant other than lithium is used.

Although a charge and discharge principle of the secondary battery is not particularly limited, the following description deals with a case where a battery capacity is obtained through insertion and extraction of the electrode reactant. The secondary battery may include a positive electrode, a negative electrode, and an electrolyte. In the secondary battery, to prevent precipitation of the electrode reactant on a surface of the negative electrode during charging, a charge capacity of the negative electrode may be greater than a discharge capacity of the positive electrode. For example, an electrochemical capacity per unit area of the negative electrode may be set to be greater than an electrochemical capacity per unit area of the positive electrode.

The electrode reactant is not particularly limited in kind, as described above. For example, the electrode reactant may be a light metal such as an alkali metal or an alkaline earth metal. Non-limiting examples of the alkali metal may include lithium, sodium, and potassium. Non-limiting examples of the alkaline earth metal may include beryllium, magnesium, and calcium.

In the following, described as an example is a case where the electrode reactant is lithium. A secondary battery in which the battery capacity is obtained through insertion and extraction of lithium may be what is called a lithium-ion secondary battery. In the lithium-ion secondary battery, lithium may be inserted and extracted in an ionic state.

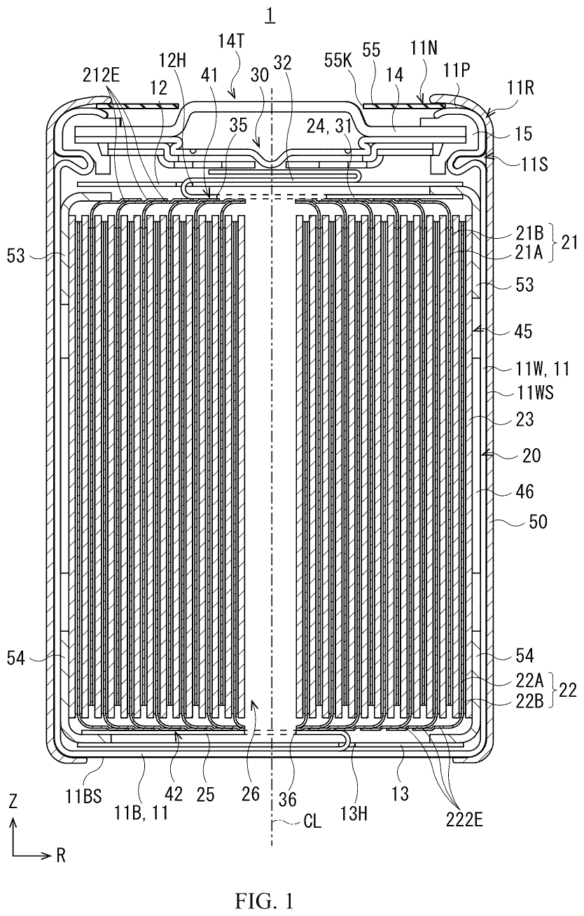

FIG. 1 illustrates a vertical sectional configuration, along a height direction, of a lithium-ion secondary battery 1 according to the present example embodiment. The lithium-ion secondary battery 1 according to the present example embodiment may be hereinafter simply referred to as the “secondary battery 1”. The secondary battery 1 illustrated in FIG. 1 may include an outer package can 11 and an electrode wound body 20. The outer package can 11 may have a substantially cylindrical shape. The electrode wound body 20 may be contained inside the outer package can 11 and may serve as a battery device. The secondary battery 1 may further include an outer package tube 50. The outer package tube 50 may cover an outer peripheral surface of the outer package can 11. Note that, herein, the height direction of the secondary battery 1 corresponds to a Z-axis direction.

For example, the secondary battery 1 may include, inside the outer package can 11, a pair of insulating plates 12 and 13, the electrode wound body 20, a positive electrode current collector plate 24, and a negative electrode current collector plate 25. The electrode wound body 20 may be a structure in which a positive electrode 21 and a negative electrode 22 are stacked on each other with a separator 23 interposed therebetween and are wound, for example. The electrode wound body 20 may be impregnated with an electrolytic solution. The electrolytic solution may be a liquid electrolyte. In some embodiments, the secondary battery 1 may further include a thermosensitive resistive device, a reinforcing member, or both inside the outer package can 11. Non-limiting examples of the thermosensitive resistive device may include a positive temperature coefficient (PTC) device.

The positive electrode current collector plate 24 may correspond to a specific but non-limiting example of a “first electrode current collector plate” in an embodiment of the present disclosure. The negative electrode current collector plate 25 may correspond to a specific but non-limiting example of a “second electrode current collector plate” in an embodiment of the present disclosure.

The outer package can 11 may contain components including, without limitation, the positive electrode current collector plate 24, the negative electrode current collector plate 25, and the electrode wound body 20. The outer package can 11 may include a bottom part 11B and a sidewall part 11W. The bottom part 11B may also serve as a negative electrode terminal coupled to the negative electrode 22 via the negative electrode current collector plate 25. The outer package can 11 may have, for example, a hollow cylindrical structure having a lower end part and an upper end part in the Z-axis direction. The lower end part may be closed, and the upper end part may be open. The upper end part of the outer package can 11 may thus be an open end part 11N. The lower end part of the outer package can 11 may be closed by the bottom part 11B having a substantially circular plate shape. The sidewall part 11W may be provided between the open end part 11N and the bottom part 11B and may surround the electrode wound body 20. The sidewall part 11W may so stand in the height direction and along an outer edge of the bottom part 11B as to surround the electrode wound body 20. The sidewall part 11W may include the open end part 11N on an opposite side to the bottom part 11B. The open end part 11N may be open to allow the electrode wound body 20 to be passed therethrough. The outer package can 11 may include, for example, a metal material such as iron, as a constituent material. In some embodiments, a surface of the outer package can 11 may be plated with a metal material such as nickel. The insulating plate 12 and the insulating plate 13 may be so opposed to each other as to allow the electrode wound body 20 to be interposed therebetween in the Z-axis direction, for example. Note that, herein, the open end part 11N and the vicinity thereof may be referred to as an upper part of the secondary battery 1 in the Z-axis direction, and a region where the outer package can 11 is closed and the vicinity thereof may be referred to as a lower part of the secondary battery 1 in the Z-axis direction.

The outer package tube 50 may surround a side surface 11WS that is an outer surface of the sidewall part 11W of the outer package can 11. In some embodiments, the outer package tube 50 may cover a bent part 11P positioned at the upper end part of the outer package can 11, as illustrated in FIG. 1. The bent part 11P will be described later. In some embodiments, the outer package tube 50 may cover a part of a bottom surface 11BS that is an outer surface of the bottom part 11B of the outer package can 11. The outer package tube 50 may include, for example, a thermally contractible insulating film that includes a material such as a polyester-based resin, a polyamide-based resin, or a thermoplastic elastomer resin.

A washer 55 may be provided in a gap between the outer package tube 50 and the bent part 11P of the outer package can 11. The washer 55 may be an insulating ring member that has an opening 55K in a middle region in a plane orthogonal to the height direction. Disposed in the opening 55K may be a projecting part 14T provided in a middle region of a battery cover 14. The washer 55 may include a material such as black modified polyphenylene ether, as a constituent material.

Each of the insulating plates 12 and 13 may be, for example, a dish-shaped plate having a surface perpendicular to a central axis CL as a winding center of the electrode wound body 20, that is, a surface perpendicular to a Z-axis in FIG. 1. The insulating plates 12 and 13 may be so disposed as to allow the electrode wound body 20 to be interposed therebetween in the Z-axis direction.

For example, at the open end part 11N of the outer package can 11, a structure in which the battery cover 14 and a safety valve mechanism 30 are crimped with a gasket 15 interposed between the open end part 11N and both the battery cover 14 and the safety valve mechanism 30 may be provided. The structure may be referred to as a crimped structure 11R. The outer package can 11 may be sealed by the battery cover 14, with the electrode wound body 20 and other components being contained inside the outer package can 11. The crimped structure 11R may include the bent part 11P serving as what is called a crimp part. A narrow part 11S may be provided between the bent part 11P and the insulating plate 12. The narrow part 11S may be a part of the outer package can 11 that protrudes inward.

The battery cover 14 may be a closing member that closes the open end part 11N in a state where the electrode wound body 20 and other components are contained inside the outer package can 11, for example. The battery cover 14 may be, for example, an electrical conductor that includes a material similar to the material included in the outer package can 11. The battery cover 14 may close the open end part 11N of the outer package can 11 and may be coupled to the positive electrode current collector plate 24. Therefore, the battery cover 14 may also serve as a positive electrode terminal coupled to the positive electrode 21 via the positive electrode current collector plate 24. The projecting part 14T provided in the middle region of the battery cover 14 may protrude upward, i.e., in a +Z direction, for example. As a result, a peripheral region, i.e., a region other than the middle region, of the battery cover 14 may be in contact with the safety valve mechanism 30, for example.

The gasket 15 may be a sealing member interposed between the bent part 11P of the outer package can 11 and the battery cover 14, for example. The gasket 15 may seal a gap between the bent part 11P and the battery cover 14. In some embodiments, a surface of the gasket 15 may be coated with a material such as asphalt. The gasket 15 may include any one or more of insulating materials, for example. The insulating material is not particularly limited in kind, and non-limiting examples thereof may include a polymer material such as polybutylene terephthalate (PBT) or polypropylene (PP). In some embodiments, the insulating material may be polybutylene terephthalate. One reason for this is that this helps to allow for sufficient sealing of the gap between the bent part 11P and the battery cover 14, with the outer package can 11 and the battery cover 14 being electrically separated from each other.

The safety valve mechanism 30 may be adapted to cancel the sealed state of the outer package can 11 to thereby release a pressure inside the outer package can 11, i.e., an internal pressure of the outer package can 11, on an as-needed basis upon an increase in the internal pressure of the outer package can 11, for example. Non-limiting examples of a cause of the increase in the internal pressure of the outer package can 11 may include a gas generated due to a decomposition reaction of the electrolytic solution upon charging and discharging. The internal pressure of the outer package can 11 can also increase due to heating from outside.

The electrode wound body 20 may be disposed between the positive electrode current collector plate 24 and the negative electrode current collector plate 25. The electrode wound body 20 has an upper end face 41 and a lower end face 42. The upper end face 41 faces the positive electrode current collector plate 24 in the height direction. The lower end face 42 faces the negative electrode current collector plate 25 in the height direction. The electrode wound body 20 may be a power generation device that causes charging and discharging reactions to proceed, and may be contained inside the outer package can 11. The electrode wound body 20 includes the positive electrode 21, the negative electrode 22, and the separator 23. The electrode wound body 20 may further include the electrolytic solution, i.e., a liquid electrolyte.

The positive electrode 21 may correspond to a specific but non-limiting example of a “first electrode” in an embodiment of the present disclosure. The negative electrode 22 may correspond to a specific but non-limiting example of a “second electrode” in an embodiment of the present disclosure. The upper end face 41 may correspond to a specific but non-limiting example of a “first end face” in an embodiment of the present disclosure. The lower end face 42 may correspond to a specific but non-limiting example of a “second end face” in an embodiment of the present disclosure.

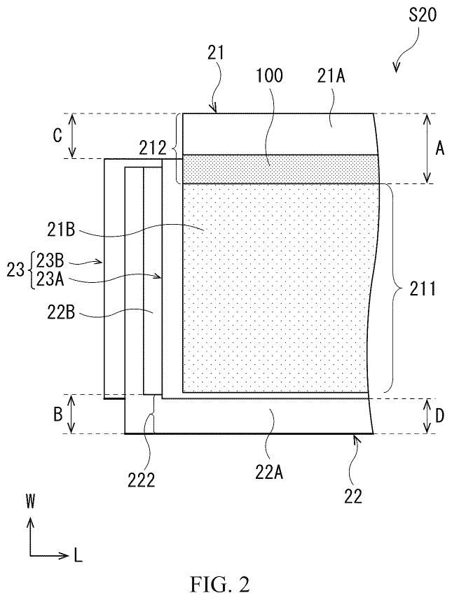

FIG. 2 is a developed view of the electrode wound body 20. In other words, FIG. 2 schematically illustrates a part of a stacked body S20 corresponding to the electrode wound body 20 in an unwound state. The stacked body S20 includes the positive electrode 21, the negative electrode 22, and the separator 23. In the stacked body S20, the positive electrode 21 and the negative electrode 22 may be stacked on each other with the separator 23 interposed therebetween. The separator 23 may include, for example, two bases, i.e., a first separator member 23A and a second separator member 23B. The electrode wound body 20 may thus include the stacked body S20 that is four-layered. In the four-layered stacked body S20, the positive electrode 21, the first separator member 23A, the negative electrode 22, and the second separator member 23B may be stacked in order. Each of the positive electrode 21, the first separator member 23A, the negative electrode 22, and the second separator member 23B may be a substantially band-shaped member in which a W direction corresponds to a transverse direction and an L direction corresponds to a longitudinal direction.

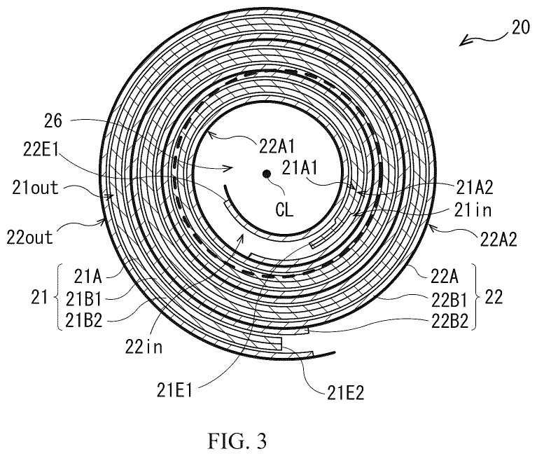

As illustrated in FIG. 3, the electrode wound body 20 may be the stacked body S20 so wound around a through hole 26 that extends along the central axis CL extending in the Z-axis direction as to form a spiral shape in a horizontal section orthogonal to the Z-axis direction. The stacked body S20 may be wound in an orientation in which the W direction substantially coincides with the Z-axis direction. Note that FIG. 3 illustrates a configuration example of the electrode wound body 20, along the horizontal section orthogonal to the Z-axis direction. Note that, for higher visibility, FIG. 3 omits illustration of the separator 23. The electrode wound body 20 may have an outer appearance of a substantially circular columnar shape as a whole. The positive electrode 21 and the negative electrode 22 may be wound, remaining in a state of being opposed to each other with the separator 23 interposed therebetween. The electrode wound body 20 may have the through hole 26 as an internal space at a center thereof. The through hole 26 may be a hole into which a winding core for assembling the electrode wound body 20 and an electrode rod for welding are each to be put. The through hole 26 may extend in the Z-axis direction along the central axis CL, and extends through the electrode wound body 20. The stacked body S20 may thus be wound around the through hole 26.

The positive electrode 21, the negative electrode 22, and the separator 23 may be so wound that the separator 23 is positioned in each of an outermost wind of the electrode wound body 20 and an innermost wind of the electrode wound body 20. In the outermost wind of the electrode wound body 20, the negative electrode 22 may be positioned on an outer side relative to the positive electrode 21. For example, as illustrated in FIG. 3, an outermost positive electrode wind part 21out positioned in an outermost wind of the positive electrode 21 included in the electrode wound body 20 may be positioned on an inner side relative to an outermost negative electrode wind part 22out positioned in an outermost wind of the negative electrode 22 included in the electrode wound body 20. Here, the outermost positive electrode wind part 21out may be a part corresponding to the outermost one wind of the positive electrode 21 in the electrode wound body 20. The outermost negative electrode wind part 22out may be a part corresponding to the outermost one wind of the negative electrode 22 in the electrode wound body 20. In contrast, in the innermost wind of the electrode wound body 20, the negative electrode 22 may be positioned on the inner side relative to the positive electrode 21. For example, as illustrated in FIG. 3, an innermost negative electrode wind part 22 in positioned in an innermost wind of the negative electrode 22 included in the electrode wound body 20 may be positioned on the inner side relative to an innermost positive electrode wind part 21 in positioned in an innermost wind of the positive electrode 21 included in the electrode wound body 20. Here, the innermost positive electrode wind part 21 in may be a part corresponding to the innermost one wind of the positive electrode 21 in the electrode wound body 20. The innermost negative electrode wind part 22 in may be a part corresponding to the innermost one wind of the negative electrode 22 in the electrode wound body 20. The number of winds of each of the positive electrode 21, the negative electrode 22, and the separator 23 is not particularly limited, and may be chosen as desired.

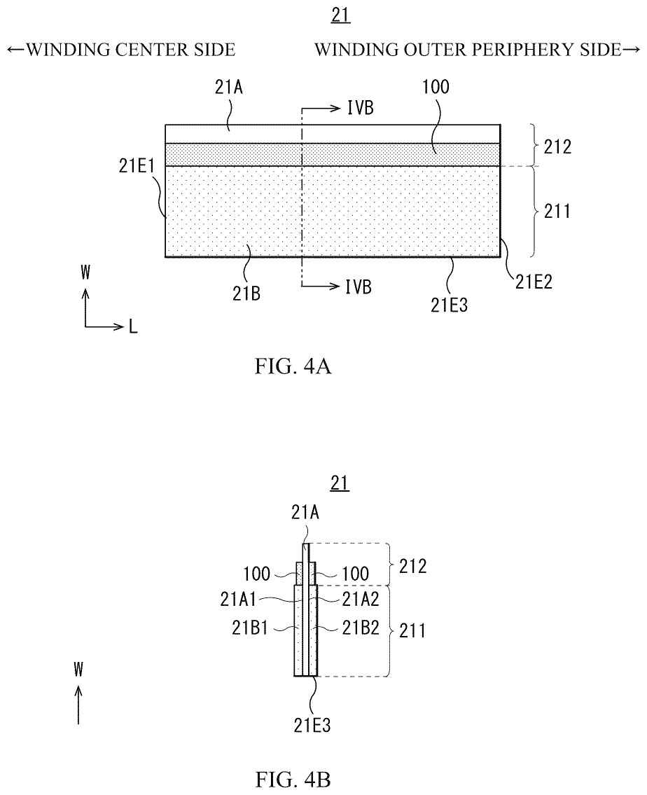

FIG. 4A is a developed view of the positive electrode 21, and schematically illustrates a state before being wound. FIG. 4B illustrates a sectional configuration of the positive electrode 21. Note that FIG. 4B illustrates a section as viewed in an arrowed direction along line IVB-IVB illustrated in FIG. 4A. In some embodiments, the positive electrode 21 may include, for example, a positive electrode current collector 21A and a positive electrode active material layer 21B. In some embodiments, the positive electrode active material layer 21B may cover a part of the positive electrode current collector 21A. The positive electrode 21 may further include an insulating layer 100. In some embodiments, the positive electrode active material layer 21B and the insulating layer 100 may be provided, for example, simply on one of two opposite surfaces of the positive electrode current collector 21A. In some embodiments, the positive electrode active material layer 21B and the insulating layer 100 may be provided, for example, on each of the two opposite surfaces of the positive electrode current collector 21A. FIG. 4B illustrates a case where the positive electrode active material layer 21B and the insulating layer 100 are provided on each of the two opposite surfaces of the positive electrode current collector 21A. For example, the positive electrode current collector 21A may include an inward positive electrode current collector surface 21A1 and an outward positive electrode current collector surface 21A2. The inward positive electrode current collector surface 21A1 may face toward a winding center side of the electrode wound body 20, i.e., toward the central axis CL. The outward positive electrode current collector surface 21A2 may face toward an opposite side to the winding center side of the electrode wound body 20. In other words, the outward positive electrode current collector surface 21A2 may be positioned on an opposite side of the positive electrode current collector 21A to the inward positive electrode current collector surface 21A1. The positive electrode 21 may include an inner winding side positive electrode active material layer 21B1 and an outer winding side positive electrode active material layer 21B2, as the positive electrode active material layers 21B. The inner winding side positive electrode active material layer 21B1 may cover all or a part of the inward positive electrode current collector surface 21A1. The outer winding side positive electrode active material layer 21B2 may cover all or a part of the outward positive electrode current collector surface 21A2. Herein, the inner winding side positive electrode active material layer 21B1 and the outer winding side positive electrode active material layer 21B2 may each be generically referred to as the positive electrode active material layer 21B, without being distinguished from each other. The positive electrode active material layer 21B may extend in both the L direction and the W direction orthogonal to the L direction. The L direction corresponds to a winding direction of the stacked body S20. The W direction substantially coincides with the central axis CL.

The positive electrode current collector 21A may correspond to a specific but non-limiting example of a “first electrode current collector” in an embodiment of the present disclosure. The positive electrode active material layer 21B may correspond to a specific but non-limiting example of a “first electrode active material layer” in an embodiment of the present disclosure.

In some embodiments, the positive electrode 21 may include a positive electrode covered region 211 and a positive electrode exposed region 212. In some embodiments, the positive electrode covered region 211 may be a region in which the positive electrode current collector 21A is covered with the positive electrode active material layer 21B. In some embodiments, the positive electrode exposed region 212 may be a region in which the positive electrode current collector 21A is exposed without being covered with the positive electrode active material layer 21B. In some embodiments, the positive electrode exposed region 212 may extend in the W direction. As illustrated in FIG. 4A, the positive electrode covered region 211 and the positive electrode exposed region 212 may each extend along the L direction, i.e., a longitudinal direction of the positive electrode 21, from a winding center side edge 21E1 of the positive electrode 21, i.e., an edge of the positive electrode 21 on the winding center side in the L direction, to a winding outer periphery side edge 21E2 of the positive electrode 21, i.e., an edge of the positive electrode 21 on a winding outer periphery side in the L direction. Here, the L direction corresponds to a winding direction of the electrode wound body 20. For example, in the positive electrode 21, the positive electrode current collector 21A may be covered with the positive electrode active material layer 21B from the winding center side edge 21E1 of the positive electrode 21 to the winding outer periphery side edge 21E2 of the positive electrode 21 in the winding direction of the electrode wound body 20. The positive electrode covered region 211 and the positive electrode exposed region 212 may be adjacent to each other in the W direction, i.e., the transverse direction of the positive electrode 21. The W direction substantially coincides with the central axis CL. The positive electrode active material layer 21B may extend in both the L direction and the W direction orthogonal to the L direction. The L direction corresponds to the longitudinal direction of the positive electrode 21. The W direction corresponds to a width direction of the positive electrode 21. As illustrated in FIG. 3, in the electrode wound body 20, the winding center side edge 21E1 at the innermost positive electrode wind part 21 in may be located at a position retracted toward the inner side from a winding center side edge 22E1 of the negative electrode 22, i.e., an edge of the negative electrode 22 on the winding center side in the L direction, at the innermost negative electrode wind part 22 in. As illustrated in FIG. 4A, the positive electrode 21 may further have a lower edge 21E3 that extends in the L direction on a lower side of the electrode wound body 20. Note that FIGS. 4A and 4B each schematically illustrate the positive electrode current collector 21A in a straightened state along the W direction. In actuality, however, as illustrated in FIG. 1, a positive electrode edge part 212E of the positive electrode exposed region 212 may be bent toward the central axis CL and may be coupled to the positive electrode current collector plate 24. For example, an end part of the positive electrode exposed region 212 in the W direction may form the upper end face 41 and may be coupled to the positive electrode current collector plate 24, as illustrated in FIG. 1. In some embodiments, the upper end face 41 may include parts, of the positive electrode edge part 212E of the positive electrode exposed region 212, that are bent toward the through hole 26 in a wound state. The positive electrode edge part 212E may include multiple parts that are adjacent to each other in a radial direction, i.e., an R direction, of the electrode wound body 20, and at least one or more of the parts may be bent toward the through hole 26.

The positive electrode covered region 211 may correspond to a specific but non-limiting example of a “first electrode covered region” in an embodiment of the present disclosure. The positive electrode exposed region 212 may correspond to a specific but non-limiting example of a “first electrode exposed region” in an embodiment of the present disclosure.

In some embodiments, the insulating layer 100 may be provided in a region including a border between the positive electrode covered region 211 and the positive electrode exposed region 212 and the vicinity of the border. In some embodiments, as with the positive electrode covered region 211 and the positive electrode exposed region 212, the insulating layer 100 may also extend from the winding center side edge 21E1 to the winding outer periphery side edge 21E2 in the electrode wound body 20. In some embodiments, the insulating layer 100 may be adhered to the first separator member 23A, the second separator member 23B, or both. One reason for this is that this helps to prevent the positive electrode 21 and the separator 23 from becoming misaligned with each other. In some embodiments, the insulating layer 100 may include a resin including polyvinylidene difluoride (PVDF). One reason for this is that when the insulating layer 100 includes PVDF, the insulating layer 100 is swollen by, for example, a solvent included in the electrolytic solution, which helps to allow the insulating layer 100 to be favorably adhered to the separator 23.

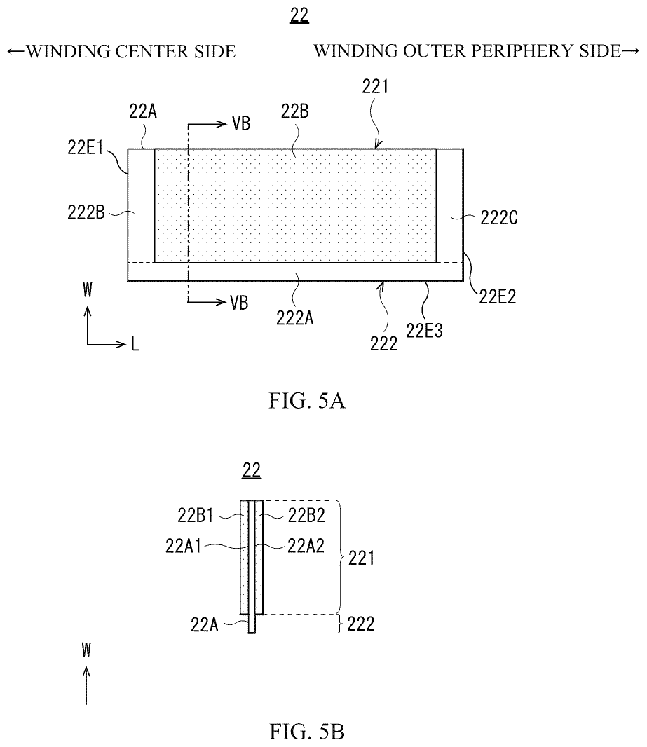

FIG. 5A is a developed view of the negative electrode 22, and schematically illustrates a state before being wound. FIG. 5B illustrates a sectional configuration of the negative electrode 22. Note that FIG. 5B illustrates a section as viewed in an arrowed direction along line VB-VB illustrated in FIG. 5A. In some embodiments, the negative electrode 22 may include, for example, a negative electrode current collector 22A and a negative electrode active material layer 22B. In some embodiments, the negative electrode active material layer 22B may cover a part of the negative electrode current collector 22A. In some embodiments, the negative electrode active material layer 22B may be provided, for example, simply on one of two opposite surfaces of the negative electrode current collector 22A. In some embodiments, the negative electrode active material layer 22B may be provided, for example, on each of the two opposite surfaces of the negative electrode current collector 22A. FIG. 5B illustrates an example case where the negative electrode active material layer 22B is provided on each of the two opposite surfaces of the negative electrode current collector 22A. For example, the negative electrode current collector 22A may include an inward negative electrode current collector surface 22A1 facing toward the central axis CL, and an outward negative electrode current collector surface 22A2 positioned on an opposite side to the inward negative electrode current collector surface 22A1. The negative electrode 22 may include an inner winding side negative electrode active material layer 22B1 and an outer winding side negative electrode active material layer 22B2, as the negative electrode active material layers 22B. The inner winding side negative electrode active material layer 22B1 may cover all or a part of the inward negative electrode current collector surface 22A1. The outer winding side negative electrode active material layer 22B2 may cover all or a part of the outward negative electrode current collector surface 22A2. Herein, the inner winding side negative electrode active material layer 22B1 and the outer winding side negative electrode active material layer 22B2 may each be generically referred to as the negative electrode active material layer 22B, without being distinguished from each other.

The negative electrode current collector 22A may correspond to a specific but non-limiting example of a “second electrode current collector” in an embodiment of the present disclosure. The negative electrode active material layer 22B may correspond to a specific but non-limiting example of a “second electrode active material layer” in an embodiment of the present disclosure.

In some embodiments, the negative electrode 22 may include a negative electrode covered region 221 and a negative electrode exposed region 222. The negative electrode covered region 221 may be a region in which the negative electrode current collector 22A is covered with the negative electrode active material layer 22B. The negative electrode exposed region 222 may be a region in which the negative electrode current collector 22A is exposed without being covered with the negative electrode active material layer 22B. As illustrated in FIG. 5A, the negative electrode covered region 221 and the negative electrode exposed region 222 may each extend along the L direction. The negative electrode exposed region 222 may extend from the winding center side edge 22E1 of the negative electrode 22 to a winding outer periphery side edge 22E2 of the negative electrode 22, i.e., an edge of the negative electrode 22 on the winding outer periphery side, in the winding direction of the electrode wound body 20. In contrast, the negative electrode covered region 221 may be provided at neither the winding center side edge 22E1 nor the winding outer periphery side edge 22E2 of the negative electrode 22. As illustrated in FIG. 5A, parts of the negative electrode exposed region 222 may be so provided as to allow the negative electrode covered region 221 to be interposed therebetween in the L direction. For example, the negative electrode exposed region 222 may include a first part 222A, a second part 222B, and a third part 222C. The negative electrode 22 may further have a lower edge 22E3 that extends in the L direction on the lower side of the electrode wound body 20. The first part 222A may be adjacent to the negative electrode covered region 221 in the W direction and may extend from the winding center side edge 22E1 of the negative electrode 22 to the winding outer periphery side edge 22E2 of the negative electrode 22 in the L direction. For example, the first part 222A may be a region extending from the negative electrode active material layer 22B in the W direction. The second part 222B and the third part 222C may be so provided as to allow the negative electrode covered region 221 to be interposed therebetween in the L direction. The first part 222A may be positioned in a region including the lower edge 22E3 and the vicinity thereof in the negative electrode 22. For example, the second part 222B may be positioned in a region including the winding center side edge 22E1 and the vicinity thereof in the negative electrode 22, and the third part 222C may be positioned in a region including the winding outer periphery side edge 22E2 and the vicinity thereof in the negative electrode 22. Note that FIGS. 5A and 5B each schematically illustrate the negative electrode current collector 22A in the straightened state along the W direction. In actuality, however, as illustrated in FIG. 1, a negative electrode edge part 222E of the negative electrode exposed region 222 may be bent toward the central axis CL and may be coupled to the negative electrode current collector plate 25. For example, an end part of the negative electrode exposed region 222 in the W direction may form the lower end face 42 and may be coupled to the negative electrode current collector plate 25, as illustrated in FIG. 1. In some embodiments, the lower end face 42 may include parts, of the negative electrode edge part 222E of the negative electrode exposed region 222, that are bent toward the through hole 26 in a wound state. The negative electrode edge part 222E may include multiple parts that are adjacent to each other in the radial direction, i.e., the R direction, of the electrode wound body 20, and at least one or more of the parts may be bent toward the through hole 26.

The negative electrode covered region 221 may correspond to a specific but non-limiting example of a “second electrode covered region” in an embodiment of the present disclosure. The negative electrode exposed region 222 may correspond to a specific but non-limiting example of a “second electrode exposed region” in an embodiment of the present disclosure.

In the stacked body S20 of the electrode wound body 20, the positive electrode 21 and the negative electrode 22 may be so stacked on each other with the separator 23 interposed therebetween that the positive electrode exposed region 212 and the first part 222A of the negative electrode exposed region 222 face toward mutually opposite directions along the W direction, i.e., the width direction. In the electrode wound body 20, an end part of the separator 23 may be fixed by attaching a fixing tape 46 to a side surface part 45 of the electrode wound body 20 to thereby prevent loosening of winding.

In some embodiments, as illustrated in FIG. 2, the secondary battery 1 may satisfy A>B, where A is a width of the positive electrode exposed region 212, and B is a width of the first part 222A of the negative electrode exposed region 222. For example, when the width A is 7 (mm), the width B may be 4 (mm). In some embodiments, the secondary battery 1 may satisfy C>D, where C is a width of a portion of the positive electrode exposed region 212 protruding from an outer edge in the width direction of the separator 23, and D is a length of a portion of the first part 222A of the negative electrode exposed region 222 protruding from an opposite outer edge in the width direction of the separator 23. For example, when the width Cis 4.5 (mm), the width D may be 3 (mm).

As illustrated in FIG. 1, in the upper part of the secondary battery 1, multiple parts of the positive electrode edge part 212E, of the positive electrode exposed region 212 wound around the central axis CL, that are adjacent to each other in the radial direction, i.e., the R direction, of the electrode wound body 20 may be so bent toward the central axis CL as to overlap each other. The parts of the positive electrode edge part 212E may thus form the upper end face 41 of the electrode wound body 20. Similarly, in the lower part of the secondary battery 1, multiple parts of the negative electrode edge part 222E, of the negative electrode exposed region 222 wound around the central axis CL, that are adjacent to each other in the radial direction, i.e., the R direction, may be so bent toward the central axis CL as to overlap each other. The parts of the negative electrode edge part 222E may thus form the lower end face 42 of the electrode wound body 20. Accordingly, the parts of the positive electrode edge part 212E of the positive electrode exposed region 212 may gather at the upper end face 41 of the electrode wound body 20, and the parts of the negative electrode edge part 222E of the negative electrode exposed region 222 may gather at the lower end face 42 of the electrode wound body 20. To achieve better contact between the positive electrode current collector plate 24 for extracting a current and the positive electrode edge part 212E, the parts of the positive electrode edge part 212E bent toward the central axis CL may form a flat surface. Similarly, to achieve better contact between the negative electrode current collector plate 25 for extracting a current and the negative electrode edge part 222E, the parts of the negative electrode edge part 222E bent toward the central axis CL may form a flat surface. Note that as used herein, the term “flat surface” may encompass not only a completely flat surface but also a surface having some asperities or surface roughness to the extent that joining of the positive electrode exposed region 212 to the positive electrode current collector plate 24 and joining of the negative electrode exposed region 222 to the negative electrode current collector plate 25 are possible.

The positive electrode current collector 21A may include an electrically conductive foil such as an aluminum foil, as will be described later. The negative electrode current collector 22A may include an electrically conductive foil such as a copper foil, as will be described later. In this case, the positive electrode current collector 21A may be softer than the negative electrode current collector 22A. For example, the positive electrode exposed region 212 may have a Young's modulus lower than a Young's modulus of the negative electrode exposed region 222. Accordingly, in some embodiments, the secondary battery 1 may satisfy both A>B and C>D regarding the widths A to D. In such a case, when the positive electrode exposed region 212 and the negative electrode exposed region 222 are substantially simultaneously bent with substantially equal pressures from both electrode sides, the bent portion in the positive electrode 21 and the bent portion in the negative electrode 22 may sometimes become substantially equal in height measured from respective ends of the separator 23. In this case, the parts of the positive electrode edge part 212E illustrated in FIG. 1 may appropriately overlap each other by being bent. This helps to allow for easy joining of the positive electrode exposed region 212 and the positive electrode current collector plate 24 to each other. Similarly, the parts of the negative electrode edge part 222E illustrated in FIG. 1 may appropriately overlap each other by being bent. This helps to allow for easy joining of the negative electrode exposed region 222 and the negative electrode current collector plate 25 to each other. As used herein, the term “joining” may refer to coupling by, for example, laser welding; however, a method of joining is not limited to laser welding. In some embodiments, any other suitable coupling method may be used.

As illustrated in FIG. 2, a portion, of the positive electrode exposed region 212 of the positive electrode 21, that is opposed to the negative electrode 22 with the separator 23 interposed therebetween may be covered with the insulating layer 100. The insulating layer 100 may have a width of 3 mm in the W direction, for example. The insulating layer 100 may entirely cover a portion, of the positive electrode exposed region 212 of the positive electrode 21, that is opposed to the negative electrode covered region 221 of the negative electrode 22 with the separator 23 interposed therebetween. The insulating layer 100 helps to effectively prevent an internal short circuit of the secondary battery 1 when foreign matter enters between the negative electrode covered region 221 and the positive electrode exposed region 212, for example. Further, when the secondary battery 1 undergoes an impact, the insulating layer 100 absorbs the impact, thereby helping to effectively prevent, for example, bending of the positive electrode exposed region 212 or a short circuit between the positive electrode exposed region 212 and the negative electrode 22.

The positive electrode current collector 21A may include an electrically conductive material such as aluminum, for example. The positive electrode current collector 21A may be, for example, a metal foil including a material such as aluminum or an aluminum alloy.

The positive electrode active material layer 21B may include, as a positive electrode active material, any one or more of positive electrode materials into which lithium is insertable and from which lithium is extractable. In some embodiments, the positive electrode active material layer 21B may further include any one or more of other materials including, without limitation, a positive electrode binder and a positive electrode conductor. In some embodiments, the positive electrode material may be a lithium-containing compound. In some embodiments, the lithium-containing compound may be, for example but not limited to, a lithium-containing composite oxide or a lithium-containing phosphoric acid compound. The lithium-containing composite oxide may be an oxide including lithium and one or more of other elements, that is, one or more of elements other than lithium, as constituent elements. The lithium-containing composite oxide may have any of crystal structures including, without limitation, a layered rock-salt crystal structure and a spinel crystal structure, for example. The lithium-containing phosphoric acid compound may be a phosphoric acid compound including lithium and one or more of other elements as constituent elements. The lithium-containing phosphoric acid compound may have a crystal structure such as an olivine crystal structure, for example. In some embodiments, the positive electrode active material layer 21B may include, as the positive electrode active material, at least one of lithium cobalt oxide, lithium nickel cobalt manganese oxide, or lithium nickel cobalt aluminum oxide. The positive electrode binder may include, for example, any one or more of materials including, without limitation, a synthetic rubber and a polymer compound. Non-limiting examples of the synthetic rubber may include a styrene-butadiene-based rubber, a fluorine-based rubber, and ethylene propylene diene. Non-limiting examples of the polymer compound may include polyvinylidene difluoride and polyimide. The positive electrode conductor may include, for example, any one or more of materials including, without limitation, a carbon material. Non-limiting examples of the carbon material may include graphite, carbon black, acetylene black, and Ketjen black. In some embodiments, the positive electrode conductor may be any of electrically conductive materials, and may be, for example, a metal material or an electrically conductive polymer.

The negative electrode current collector 22A may include an electrically conductive material such as copper, for example. The negative electrode current collector 22A may be, for example, a metal foil including a material such as nickel, a nickel alloy, copper, or a copper alloy. In some embodiments, a surface of the negative electrode current collector 22A may be roughened. One reason for this is that this helps to improve adherence of the negative electrode active material layer 22B to the negative electrode current collector 22A, owing to what is called an anchor effect. In this case, it may suffice that the surface of the negative electrode current collector 22A is roughened at least in a region facing the negative electrode active material layer 22B. Non-limiting examples of a roughening method may include a method in which microparticles are formed through an electrolytic treatment. In the electrolytic treatment, the microparticles may be formed on the surface of the negative electrode current collector 22A by an electrolytic method in an electrolyzer. This may provide the surface of the negative electrode current collector 22A with asperities. A copper foil fabricated by the electrolytic method may be generally called an electrolytic copper foil.

The negative electrode active material layer 22B may include, as a negative electrode active material, any one or more of negative electrode materials into which lithium is insertable and from which lithium is extractable. In some embodiments, the negative electrode active material layer 22B may further include any one or more of other materials including, without limitation, a negative electrode binder and a negative electrode conductor. The negative electrode material may be an electrically conductive material such as a carbon material. One reason for this is that the carbon material exhibits very little change in crystal structure at the time of insertion and extraction of lithium, which helps to stably obtain a high energy density. Another reason is that the carbon material also serves as the negative electrode conductor, which helps to improve electrical conductivity of the negative electrode active material layer 22B. The carbon material may be, for example but not limited to, graphitizable carbon, non-graphitizable carbon, or graphite. In some embodiments, spacing of a (002) plane of the non-graphitizable carbon may be 0.37 nm or greater. In some embodiments, spacing of a (002) plane of the graphite may be 0.34 nm or less. Non-limiting examples of the carbon material may include pyrolytic carbons, cokes, glassy carbon fibers, an organic polymer compound fired body, activated carbon, and carbon blacks. Non-limiting examples of the cokes may include pitch coke, needle coke, and petroleum coke. The organic polymer compound fired body may be a resultant of firing or carbonizing a polymer compound such as a phenol resin or a furan resin at a suitable temperature. Other than the above, in some embodiments, the carbon material may be low-crystalline carbon heat-treated at a temperature of about 1000° C. or lower. In some embodiments, the carbon material may be amorphous carbon. In some embodiments, the carbon material may have any of a fibrous shape, a spherical shape, a granular shape, or a flaky shape. In the secondary battery 1, when an open-circuit voltage in a fully charged state, that is, a battery voltage, is 4.25 V or higher, the amount of extracted lithium per unit mass may increase as compared with when the open-circuit voltage in the fully charged state is 4.20 V, even with the same positive electrode active material. The amount of the positive electrode active material and the amount of the negative electrode active material may be therefore adjusted accordingly. This helps to obtain a high energy density.

In some embodiments, the negative electrode active material layer 22B may include, as the negative electrode active material, a silicon-containing material including at least one of silicon, a silicon oxide, a carbon-silicon compound, or a silicon alloy. The term “silicon-containing material” may be a generic term for a material that includes silicon as a constituent element. In some embodiments, the silicon-containing material may include only silicon as a constituent element. In some embodiments, only one kind of silicon-containing material may be used. In some embodiments, two or more kinds of silicon-containing materials may be used. The silicon-containing material may be able to form an alloy with lithium, and may be: a simple substance of silicon; a silicon alloy; a silicon compound; a mixture of two or more of a simple substance of silicon, a silicon alloy, or a silicon compound; or a material including one or more phases of a simple substance of silicon, a silicon alloy, and a silicon compound. The silicon-containing material may be crystalline or amorphous, or may include both a crystalline part and an amorphous part. Note that the simple substance described here may refer to a simple substance merely in a general sense. In some embodiments, the simple substance may thus include a small amount of impurity. In other words, purity of the simple substance is not necessarily limited to 100%. The silicon alloy may include, as one or more constituent elements other than silicon, any one or more of elements including, without limitation, tin, nickel, copper, iron, cobalt, manganese, zinc, indium, silver, titanium, germanium, bismuth, antimony, and chromium, for example. The silicon compound may include, as one or more constituent elements other than silicon, any one or more of elements including, without limitation, carbon and oxygen, for example. In some embodiments, the silicon compound may include, as one or more constituent elements other than silicon, any one or more of the series of constituent elements described above in relation to the silicon alloy, for example. Non-limiting examples of the silicon alloy and the silicon compound may include SiB₄, SiB₆, Mg₂Si, NizSi, TiSi₂, MoSi₂, CoSi₂, NiSi₂, CaSi₂, CrSi₂, CusSi, FeSi₂, MnSi₂, NbSi₂, TaSi₂, VSiz, WSi₂, ZnSi₂, SiC, Si₃N₄, Si₂N₂O, and SiO. (where 0<v≤2). Note that, the range of v may be chosen as desired, and may be, for example, 0.2<v<1.4.

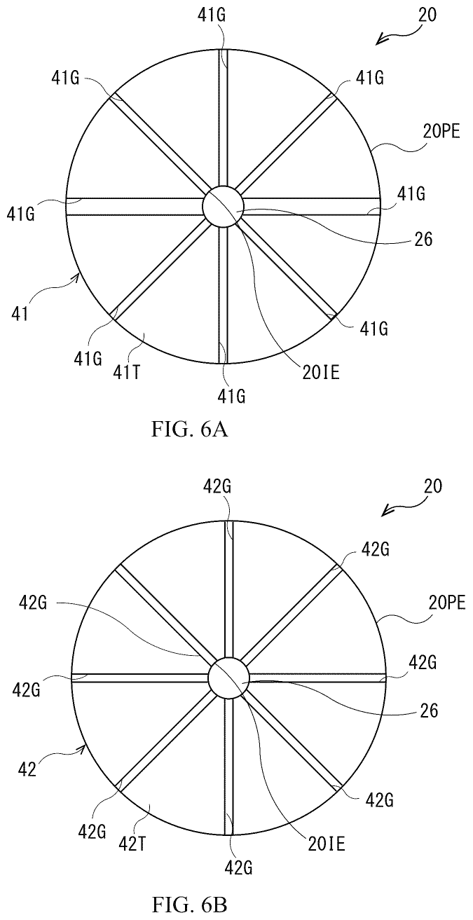

FIG. 6A is a plan diagram schematically illustrating an example state of the upper end face 41 of the electrode wound body 20 as viewed from the positive electrode current collector plate 24. The upper end face 41 may include parts, of the positive electrode edge part 212E in the W direction of the positive electrode exposed region 212, that are bent toward the through hole 26 in a state where the stacked body S20 is wound. In some embodiments, as illustrated in FIG. 6A, the upper end face 41 may have one or more grooves 41G and an ungrooved part 41T. In some embodiments, the one or more grooves 41G may each extend from an outer edge 20PE of the electrode wound body 20 toward an inner edge 20IE of the electrode wound body 20. In some embodiments, the ungrooved part 41T may lie closer to the positive electrode current collector plate 24 than the one or more grooves 41G. Here, the one or more grooves 41G may each be continuous from the outer edge 20PE to the inner edge 20IE, or may be discontinuous in a middle. In some embodiments, the one or more grooves 41G may include multiple grooves 41G, and the multiple grooves 41G may have respective lengths that are substantially equal to each other. In some embodiments, the multiple grooves 41G may have respective shapes that are substantially identical to each other. For example, the multiple grooves 41G may be substantially identical to each other in plan shape or sectional shape. FIG. 6A illustrates an example case where the upper end face 41 has eight grooves 41G and eight ungrooved parts 41T. In some embodiments, the one or more grooves 41G may be 3 or more and 16 or less in number. The eight grooves 41G may extend radiately in radial directions from the through hole 26 at the center. The ungrooved part 41T may be a portion, of the upper end face 41, excluding the grooves 41G. The ungrooved part 41T of the upper end face 41 may be joined to the positive electrode current collector plate 24.

FIG. 6B is a plan diagram schematically illustrating an example state of the lower end face 42 of the electrode wound body 20 as viewed from the negative electrode current collector plate 25. The lower end face 42 may include parts, of the negative electrode edge part 222E in the W direction of the negative electrode exposed region 222, that are bent toward the through hole 26 in the state where the stacked body S20 is wound. In some embodiments, as illustrated in FIG. 6B, the lower end face 42 may have one or more grooves 42G and an ungrooved part 42T. In some embodiments, the one or more grooves 42G may each extend from the outer edge 20PE of the electrode wound body 20 toward the inner edge 20IE of the electrode wound body 20. In some embodiments, the ungrooved part 42T may lie closer to the negative electrode current collector plate 25 than the one or more grooves 42G. Here, the one or more grooves 42G may each be continuous from the outer edge 20PE to the inner edge 20IE, or may be discontinuous in a middle. In some embodiments, the one or more grooves 42G may include multiple grooves 42G, and the multiple grooves 42G may have respective lengths that are substantially equal to each other. In some embodiments, the multiple grooves 42G may have respective shapes that are substantially identical to each other. For example, the multiple grooves 42G may be substantially identical to each other in plan shape or sectional shape. FIG. 6B illustrates an example case where the lower end face 42 has eight grooves 42G and eight ungrooved parts 42T. In some embodiments, the one or more grooves 42G may be 3 or more and 16 or less in number. The eight grooves 42G may extend radiately in radial directions from the through hole 26 at the center. The ungrooved part 42T may be a portion, of the lower end face 42, excluding the grooves 42G. The ungrooved part 42T of the lower end face 42 may be joined to the negative electrode current collector plate 25.

In some embodiments, the secondary battery 1 may further include insulating tapes 53 and 54 in a gap between the outer package can 11 and the electrode wound body 20. The positive electrode exposed region 212 having parts gathering at the upper end face 41 and the negative electrode exposed region 222 having parts gathering at the lower end face 42 may be electrical conductors, such as metal foils, that are exposed. Accordingly, if the positive electrode exposed region 212 and the negative electrode exposed region 222 are in close proximity to the outer package can 11, a short circuit between the positive electrode 21 and the negative electrode 22 can occur via the outer package can 11. A short circuit can also occur when the positive electrode current collector plate 24 that faces the upper end face 41 comes into close proximity to the outer package can 11. To address this, in some embodiments, the insulating tapes 53 and 54 may be provided as insulating members. Each of the insulating tapes 53 and 54 may be an adhesive tape including a base layer and an adhesive layer provided on one surface of the base layer. The base layer may include, for example, any one of polypropylene, polyethylene terephthalate, or polyimide. To prevent the provision of the insulating tapes 53 and 54 from resulting in a decreased capacity of the electrode wound body 20, the insulating tapes 53 and 54 may be disposed not to overlap the fixing tape 46 attached to the side surface part 45, and may each have a thickness set to be less than or equal to a thickness of the fixing tape 46.

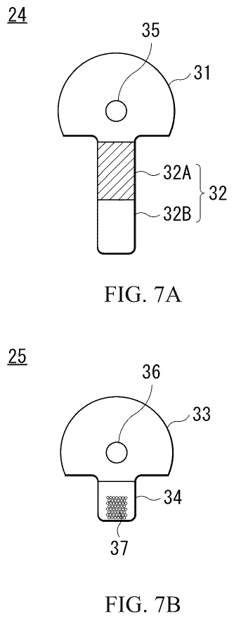

In a general lithium-ion secondary battery, for example, a lead for current extraction is welded to each of a positive electrode and a negative electrode. However, such a structure increases an internal resistance of the lithium-ion secondary battery, causing the lithium-ion secondary battery to generate heat and become hot upon discharging; therefore, the structure is unsuitable for discharging at a high rate. To address this, in the secondary battery 1 according to the present example embodiment, the positive electrode current collector plate 24 may be disposed to face the upper end face 41, and the negative electrode current collector plate 25 may be disposed to face the lower end face 42. In addition, the positive electrode exposed region 212 that forms the upper end face 41 and the positive electrode current collector plate 24 may be welded to each other at multiple points; and the negative electrode exposed region 222 that forms the lower end face 42 and the negative electrode current collector plate 25 may be welded to each other at multiple points. This helps to allow for a reduced internal resistance of the secondary battery 1. Each of the upper end face 41 and the lower end face 42 being a flat surface as described above also contributes to the reduced resistance. The positive electrode current collector plate 24 may be disposed between the battery cover 14 and the upper end face 41. The positive electrode current collector plate 24 may be electrically coupled to the battery cover 14 via the safety valve mechanism 30, for example. The negative electrode current collector plate 25 may be disposed between the bottom part 11B of the outer package can 11 and the lower end face 42. The negative electrode current collector plate 25 may be electrically coupled to an inner surface of the bottom part 11B of the outer package can 11, for example. FIG. 7A is a developed diagram illustrating a configuration example of the positive electrode current collector plate 24. FIG. 7B is a developed diagram illustrating a configuration example of the negative electrode current collector plate 25. The positive electrode current collector plate 24 may be a metal plate including, for example but not limited to, aluminum or an aluminum alloy as a single component, or a composite material of aluminum and the aluminum alloy. The negative electrode current collector plate 25 may be a metal plate including, for example but not limited to, nickel, a nickel alloy, copper, or a copper alloy as a single component, or a composite material of two or more thereof.

As illustrated in FIG. 7A, the positive electrode current collector plate 24 may include a fan-shaped part 31 and a band-shaped part 32. The fan-shaped part 31 may have a substantially fan shape. The band-shaped part 32 may have a substantially rectangular shape. A shape of the positive electrode current collector plate 24 is, however, not limited to the shape illustrated in FIG. 7A, and may be chosen as desired. Note that in the secondary battery 1, the positive electrode current collector plate 24 may be contained inside the outer package can 11, as illustrated in FIG. 1, in a state where the band-shaped part 32 is bent with respect to the fan-shaped part 31. FIG. 7A illustrates the positive electrode current collector plate 24 in an unbent state. The fan-shaped part 31 may be a facing part facing and coupled to the ungrooved part 41T of the upper end face 41. The fan-shaped part 31 may have an outer edge including a linear part and a curved part, for example. The fan-shaped part 31 may have an opening 35 in the vicinity of a middle thereof. FIG. 7A illustrates an example case where the opening 35 has a circular plan shape in a horizontal plane orthogonal to the Z-axis direction. The band-shaped part 32 may be coupled to the linear part of the outer edge of the fan-shaped part 31, for example. The band-shaped part 32 may extend in a direction intersecting with the linear part of the fan-shaped part 31. As illustrated in FIG. 1, in the secondary battery 1, the positive electrode current collector plate 24 may be so provided as to allow the opening 35 to overlap the through hole 26 in the Z-axis direction. For example, the opening 35 may be positioned to overlap, in the Z-axis direction, a part of the upper end face 41 on the winding center side.

A hatched portion in FIG. 7A represents an insulating part 32A of the band-shaped part 32. The insulating part 32A may be a part of the band-shaped part 32 and may have an insulating tape attached thereto or an insulating material applied thereto. Of the band-shaped part 32, a portion below the insulating part 32A may be a coupling part 32B to be coupled to a sealing plate that also serves as an external terminal. The sealing plate may be electrically continuous with the battery cover 14. Note that when the secondary battery 1 has a battery structure without a metallic center pin in the through hole 26 as illustrated in FIG. 1, there is a low possibility that the band-shaped part 32 will come into contact with a region of a negative electrode potential. In some embodiments, the positive electrode current collector plate 24 does not have to include the insulating part 32A. When the positive electrode current collector plate 24 does not include the insulating part 32A, a charge and discharge capacity is allowed to be increased by increasing a width of each of the positive electrode 21 and the negative electrode 22 by an amount corresponding to a thickness of the insulating part 32A.

The negative electrode current collector plate 25 illustrated in FIG. 7B may have a shape similar to the shape of the positive electrode current collector plate 24 illustrated in FIG. 7A. The negative electrode current collector plate 25 may include a fan-shaped part 33 and a band-shaped part 34. The fan-shaped part 33 may have a substantially fan shape. The band-shaped part 34 may have a substantially rectangular shape. The shape of the negative electrode current collector plate 25 is, however, not limited to the shape illustrated in FIG. 6B, and may be chosen as desired. Note that in the secondary battery 1, the negative electrode current collector plate 25 may be contained inside the outer package can 11, as illustrated in FIG. 1, in a state where the band-shaped part 34 is bent with respect to the fan-shaped part 33. FIG. 7B illustrates the negative electrode current collector plate 25 in an unbent state. The fan-shaped part 33 may be a facing part facing and coupled to the ungrooved part 42T of the lower end face 42. The fan-shaped part 33 may have an outer edge including a linear part and a curved part, for example. The band-shaped part 34 may be coupled to the linear part of the outer edge of the fan-shaped part 33, for example. The band-shaped part 34 may extend in a direction intersecting with the linear part of the fan-shaped part 33. The band-shaped part 34 of the negative electrode current collector plate 25 may be shorter than the band-shaped part 32 of the positive electrode current collector plate 24, and may include no portion corresponding to the insulating part 32A of the positive electrode current collector plate 24. The band-shaped part 34 may be provided with projections 37 that are depicted as circles. The projections 37 may each be of a round shape. All or a part of the projections 37 may be welded to the bottom part 11B of the outer package can 11. Upon resistance welding, a current may be concentrated on the projections 37, causing the projections 37 to melt to cause the band-shaped part 34 to be welded to the bottom part 11B of the outer package can 11. As with the positive electrode current collector plate 24, the negative electrode current collector plate 25 may have an opening 36 in the vicinity of a middle of the fan-shaped part 33. In the secondary battery 1, the negative electrode current collector plate 25 may be so provided as to allow the opening 36 to overlap the through hole 26 in the Z-axis direction. FIG. 7B illustrates an example case where the opening 36 has a circular plan shape in a horizontal plane orthogonal to the Z-axis direction.

The fan-shaped part 31 of the positive electrode current collector plate 24 may simply cover a part of the upper end face 41, owing to a plan shape of the fan-shaped part 31. Similarly, the fan-shaped part 33 of the negative electrode current collector plate 25 may simply cover a part of the lower end face 42, owing to a plan shape of the fan-shaped part 33. Reasons why the fan-shaped part 31 and the fan-shaped part 33 do not respectively cover the entire upper end face 41 and the entire lower end face 42 include, for example but not limited to, the following reasons. One reason is to allow the electrolytic solution to smoothly permeate the electrode wound body 20 in assembling the secondary battery 1, for example. In the secondary battery 1 according to the present example embodiment, the positive electrode current collector plate 24 may be so provided as to allow the opening 35 to overlap a part of the upper end face 41 on the winding center side in the Z-axis direction. Accordingly, one or more, but not all, of the parts of the positive electrode edge part 212E forming the upper end face 41 may not be covered with the fan-shaped part 31 of the positive electrode current collector plate 24 and may be exposed from the opening 35. The secondary battery 1 may thus have a structure that allows for swifter permeation of the electrolytic solution into the electrode wound body 20. Another reason is to allow a gas generated when the lithium-ion secondary battery comes into an abnormally hot state or an overcharged state to be easily released to the outside.

The separator 23 may be interposed between the positive electrode 21 and the negative electrode 22. The separator 23 may allow lithium ions to pass through and prevent a short circuit of a current caused by contact between the positive electrode 21 and the negative electrode 22. The separator 23 may include, for example, any one or more kinds of porous films each including, for example but not limited to, a synthetic resin or a ceramic. In some embodiments, the separator 23 may include, for example, a stacked film including two or more kinds of porous films. Non-limiting examples of the synthetic resin may include polytetrafluoroethylene, polypropylene, and polyethylene. In some embodiments, the separator 23 may include a base that includes a single-layer polyolefin porous film including polyethylene. One reason for this is that this helps to obtain a favorable high output characteristic, as compared with the stacked film. In some embodiments, when each of the first separator member 23A and the second separator member 23B included in the separator 23 is a single-layer porous film including polyolefin, the single-layer porous film including polyolefin may have a thickness of greater than or equal to 10 μm and less than or equal to 15 μm, for example. Allowing the single-layer porous film including polyolefin to have a thickness of greater than or equal to 10 μm helps to sufficiently avoid an internal short circuit. Allowing the single-layer porous film including polyolefin to have a thickness of less than or equal to 15 μm helps to achieve a more favorable discharge capacity characteristic. In some embodiments, the single-layer porous film including polyolefin may have a surface density of greater than or equal to 6.3 g/m² and less than or equal to 8.3 g/m², for example. Allowing the single-layer porous film including polyolefin to have a surface density of greater than or equal to 6.3 g/m² helps to sufficiently avoid an internal short circuit. Allowing the single-layer porous film including polyolefin to have a surface density of less than or equal to 8.3 g/m² helps to achieve a more favorable discharge capacity characteristic.

In some embodiments, the separator 23 may include, for example, a porous film as the base described above, and a polymer compound layer provided on one of or each of two opposite surfaces of the base. One reason for this is that adherence of the separator 23 to each of the positive electrode 21 and the negative electrode 22 improves, which suppresses distortion of the electrode wound body 20. As a result, a decomposition reaction of the electrolytic solution is suppressed, and leakage of the electrolytic solution with which the base is impregnated is also suppressed. This helps to prevent an easy increase in resistance even upon repeated charging and discharging, and also to suppress swelling of the secondary battery. The polymer compound layer may include, for example, a polymer compound such as polyvinylidene difluoride. One reason for this is that the polymer compound such as polyvinylidene difluoride has superior physical strength and is electrochemically stable. In some embodiments, the polymer compound may be other than polyvinylidene difluoride. To form the polymer compound layer, for example, a solution in which the polymer compound is dissolved in a solvent such as an organic solvent may be applied on the base, following which the base may be dried. In some embodiments, the base may be immersed in the solution and thereafter dried. In some embodiments, the polymer compound layer may include any one or more kinds of insulating particles such as inorganic particles, for example. Non-limiting examples of the kind of the material included in the inorganic particles may include aluminum oxide and aluminum nitride.

The electrolytic solution may include a solvent and an electrolyte salt. In some embodiments, the electrolytic solution may further include any one or more of other materials. Non-limiting examples of the other materials may include an additive. The solvent may include any one or more of nonaqueous solvents including, without limitation, an organic solvent. An electrolytic solution including a nonaqueous solvent may be what is called a nonaqueous electrolytic solution. The nonaqueous solvent may include a fluorine compound and a dinitrile compound, for example. The fluorine compound may include, for example, at least one of fluorinated ethylene carbonate, trifluorocarbonate, trifluoroethyl methyl carbonate, a fluorinated carboxylic acid ester, or a fluorine ether. In some embodiments, the nonaqueous solvent may further include one or more of nitrile compounds other than the dinitrile compound. Non-limiting examples of the nitrile compounds other than the dinitrile compound may include a mononitrile compound and a trinitrile compound. In some embodiments, the dinitrile compound may include succinonitrile (SN). However, the dinitrile compound is not limited to succinonitrile, and in some embodiments, may be any other dinitrile compound such as adiponitrile.

The electrolyte salt may include, for example, any one or more of salts including, without limitation, a lithium salt. In some embodiments, the electrolyte salt may include a salt other than the lithium salt. Non-limiting examples of the salt other than the lithium salt may include a salt of a light metal other than lithium. Non-limiting examples of the lithium salt may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). In some embodiments, the lithium salt may include any one or more of LiPF₆, LiBF₄, LiClO₄, or LiAsF₆. In some embodiments, the lithium salt may be LiPF₆. A content of the electrolyte salt is not particularly limited. In some embodiments, the content of the electrolyte salt may be within a range from 0.3 mol/kg to 3 mol/kg both inclusive with respect to the solvent. In some embodiments, when the electrolytic solution includes LiPF₆ as the electrolyte salt, a concentration of LiPF₆ in the electrolytic solution may be within a range from 1.25 mol/kg to 1.45 mol/kg both inclusive. One reason for this is that this helps to prevent cycle deterioration caused by consumption or decomposition of the salt at the time of high load rate charging, and thus helps to improve a high-load cyclability characteristic. In some embodiments, when the electrolytic solution further includes LiBF₄ in addition to LiPF₆ as the electrolyte salt, a concentration of LiBF₄ in the electrolytic solution may be within a range from 0.001 wt % to 0.1 wt % both inclusive. One reason for this is that this helps to more effectively prevent the cycle deterioration caused by consumption or decomposition of the salt at the time of high load rate charging, and thus helps to further improve the high-load cyclability characteristic.

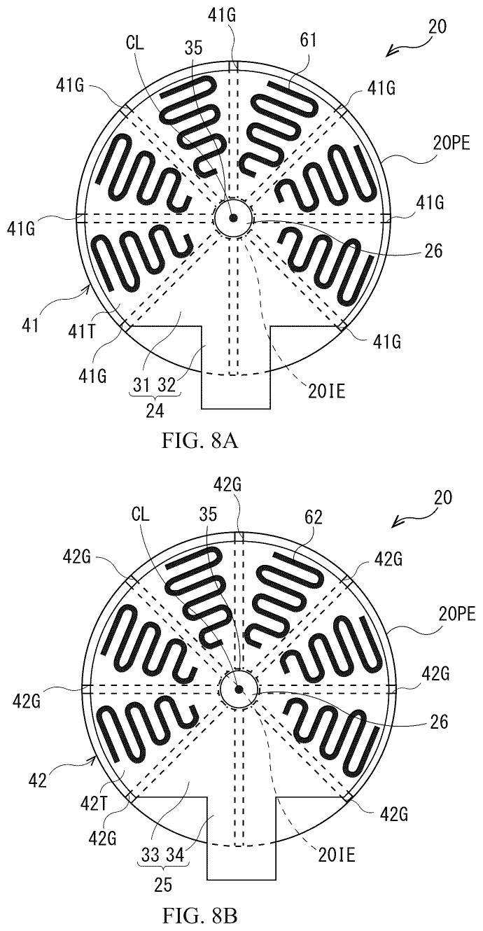

FIG. 8A illustrates a configuration example of a first joint part 61 between the upper end face 41 of the electrode wound body 20 and the positive electrode current collector plate 24, in a plane orthogonal to the central axis CL of the electrode wound body 20. As illustrated in FIG. 8A, the fan-shaped part 31 of the positive electrode current collector plate 24 and the upper end face 41 may be joined to each other by one or more first joint parts 61. The fan-shaped part 31 and the upper end face 41 may be joined by, for example, welding. As a method of welding, laser welding may be employed. The laser welding may involve scanning and irradiating a contact portion between the fan-shaped part 31 and the upper end face 41 with lasers to thereby fusion weld the contact portion. In the configuration example illustrated in FIG. 8A, one first joint part 61 is provided in each of six ungrooved parts 41T out of eight ungrooved parts 41T partitioned by eight grooves 41G. The six first joint parts 61 may each be a portion in which a part of corresponding one of the six ungrooved parts 41T and a part of the fan-shaped part 31 of the positive electrode current collector plate 24 are joined to each other. Each of the six first joint parts 61 may extend in a meandering line. For example, each of the six first joint parts 61 may extend from the central axis CL as the winding center of the electrode wound body 20 to the outer edge 20PE of the electrode wound body 20 while alternately bending left and right along the winding direction of the electrode wound body 20. The six first joint parts 61 may be spaced away from each other without intersecting with each other. In some embodiments, respective parts of adjacent ones of the first joint parts 61 may be in contact with each other. The six first joint parts 61 may be adjacent to each other so as to face each other in the radial direction of the electrode wound body 20, for example. The six first joint parts 61 may each extend orthogonally to the radial direction of electrode wound body 20, for example.

FIG. 8B illustrates a configuration example of a second joint part 62 between the lower end face 42 of the electrode wound body 20 and the negative electrode current collector plate 25, in a plane orthogonal to the central axis CL of the electrode wound body 20. As illustrated in FIG. 8B, the fan-shaped part 33 of the negative electrode current collector plate 25 and the lower end face 42 may be joined to each other by one or more second joint parts 62. The fan-shaped part 33 and the lower end face 42 may be joined by, for example, welding. In the configuration example illustrated in FIG. 8B, one second joint part 62 is provided in each of six ungrooved parts 42T out of eight ungrooved parts 42T partitioned by eight grooves 42G. The six second joint parts 62 may each be a portion in which a part of corresponding one of the six ungrooved parts 42T and a part of the fan-shaped part 33 of the negative electrode current collector plate 25 are joined to each other. Each of the six second joint parts 62 may extend in a meandering line. For example, each of the six second joint parts 62 may extend from the central axis CL as the winding center of the electrode wound body 20 to the outer edge 20PE of the electrode wound body 20 while alternately bending left and right along the winding direction of the electrode wound body 20. The six second joint parts 62 may be spaced away from each other without intersecting with each other. The six second joint parts 62 may be adjacent to each other so as to face each other in the radial direction of the electrode wound body 20, for example. The six second joint parts 62 may each extend orthogonally to the radial direction of electrode wound body 20, for example.

Although the six first joint parts 61 may be provided in the configuration example illustrated in FIG. 8A and the six second joint parts 62 may be provided in the configuration example illustrated in FIG. 8B, an embodiment of the present disclosure is not limited thereto. In some embodiments, the first joint part 61 and the second joint part 62 may each be one or more in number. In some embodiments, the first joint part 61 and the second joint part 62 may each be three or more in number. In some embodiments, the first joint part 61 and the second joint part 62 may each be four or more and six or less in number.

FIG. 9A is an enlarged schematic plan view of the first joint part 61. As illustrated in FIG. 9A, the multiple first joint parts 61 each have a meander shape in a plan view in a plane orthogonal to the through hole 26. The first joint parts 61 each have multiple first linear parts 61A and multiple first turning parts 61B. The first linear parts 61A may be so discretely disposed as to extend along the winding direction (a θ direction) of the electrode wound body 20, i.e., a direction orthogonal to the radial direction (the R direction) of the electrode wound body 20, and to be adjacent to each other in the radial direction (the R direction) of the electrode wound body 20. The first turning parts 61B may each be a curved part that is so bent as to couple corresponding two of the first linear parts 61A to each other. FIG. 9A illustrates an example in which seven first linear parts 61A1 to 61A7 are provided as the first linear parts 61A, and six first turning parts 61B1 to 61B6 are provided as the first turning parts 61B. However, the number of first linear parts 61A is not limited to a specific number as long as the number is two or more, and the number of first turning parts 61B is not limited to a specific number as long as the number is three or more. Note that in some embodiments, the first linear parts 61A and the first turning parts 61B may each have a constant width 61W.

In each of the first joint parts 61, a length 61La is longer than a length 61L1. The length 61L1 is a length in the winding direction (the θ direction) of the electrode wound body 20 from the first turning part 61B1 that is the first one of the first turning parts 61B counted from the winding center of the electrode wound body 20 to the first turning part 61B2 that is the second one of the first turning parts 61B counted from the winding center. The length 61La is a length in the winding direction (the θ direction) of the electrode wound body 20 from a first turning part 61Ba that is an a-th one of the first turning parts 61B, of the corresponding first joint part 61, counted from the winding center to a first turning part 61B(a+1) that is an (a+1)th one of the first turning parts 61B, of the corresponding first joint part 61, counted from the winding center, where the number of first turning parts 61B is represented by “n”, “n” is a natural number, and “a” is a natural number greater than or equal to two and less than “n”. For example, each of lengths 61L2 to 61L4 illustrated in FIG. 9A may be longer than the length 61L1.

In some embodiments, in the configuration example of the first joint part 61 illustrated in FIG. 9A, a length 61L(a+1) may be longer than the length 61La. The length 61La may be a length in the winding direction (the θ direction) of the electrode wound body 20 from a first turning part 61B(a−1) that is an (a−1)th one of the first turning parts 61B counted from the winding center of the electrode wound body 20 to the a-th first turning part 61Ba counted from the winding center of the electrode wound body 20, and the length 61L(a+1) may be a length in the winding direction (the θ direction) of the electrode wound body 20 from the a-th first turning part 61Ba counted from the winding center of the electrode wound body 20 to the first turning part 61B(a+1) counted from the winding center of the electrode wound body 20, where “a” is a natural number greater than or equal to two and less than or equal to (n−1). For example, in the configuration example of the first joint part 61 illustrated in FIG. 9A, the length 61L2 may be longer than the length 61L1 (61L1<61L2), the length 61L3 may be longer than the length 61L2 (61L2<61L3), and the length 61L4 may be longer than the length 61L3 (61L3<61L4). For example, in the configuration example of the first joint part 61 illustrated in FIG. 9A, a dimension in the winding direction (the θ direction) of the first joint part 61 may gradually increase toward the winding outer periphery side from the winding center side.

In some embodiments, in the configuration example of the first joint part 61 illustrated in FIG. 9A, a ratio 61L(a+1)/61La of the length 61L(a+1) to the length 61La may be substantially equal to a ratio 61L(a+2)/61L(a+1) of a length 61L(a+2) to the length 61L(a+1). The length 61L(a+2) may be a length in the winding direction (the θ direction) from the (a+1)th first turning part 61B(a+1) to a first turning part 61B(a+2) that is an (a+2)th one of the first turning parts 61B counted from the winding center. For example, a ratio (61L2)/(61L1) of the length 61L2 to the length 61L1 may be substantially equal to a ratio (61L3)/(61L2) of the length 61L3 to the length 61L2, and the ratio (61L3)/(61L2) may be substantially equal to a ratio (61L4)/(61L3) of the length 61L4 to the length 61L3. In other words, the following may be satisfied: {(61L2/61L1)} ≈{(61L3/61L2)}={(61L4/61L3)}.

FIG. 9B is a sectional diagram illustrating a section of the first joint part 61 and the vicinity thereof. The first joint part 61 may be a portion in which the fan-shaped part 31 of the positive electrode current collector plate 24 and the positive electrode edge part 212E of the positive electrode current collector 21A are joined to each other. In some embodiments, as illustrated in FIG. 9B, each of spacings 61D1 to 61D6 in the radial direction (the R direction) of the first linear parts 61A may be shorter than each of lengths 41D1 to 41D5 in the radial direction (the R direction) of parts 212E1 to 212E5, of the positive electrode edge part 212E, that form the upper end face 41. With such a configuration, each of wound parts of the electrode wound body 20 wound around the central axis CL may be joined to the fan-shaped part 31 of the positive electrode current collector plate 24. For example, the positive electrode edge part 212E of the positive electrode current collector 21A and the fan-shaped part 31 of the positive electrode current collector plate 24 may be joined to each other at a larger number of locations, which allows a current to be extracted from the electrode wound body 20 more favorably.

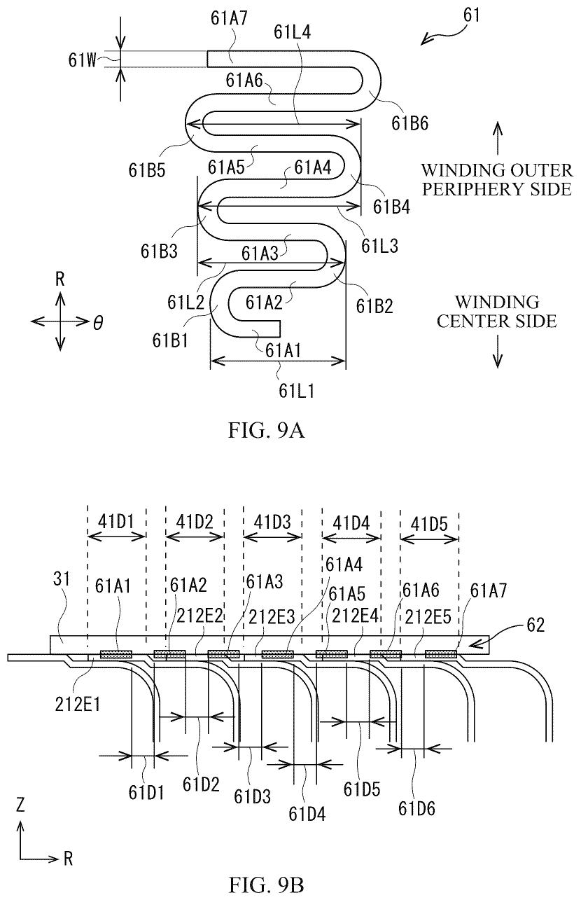

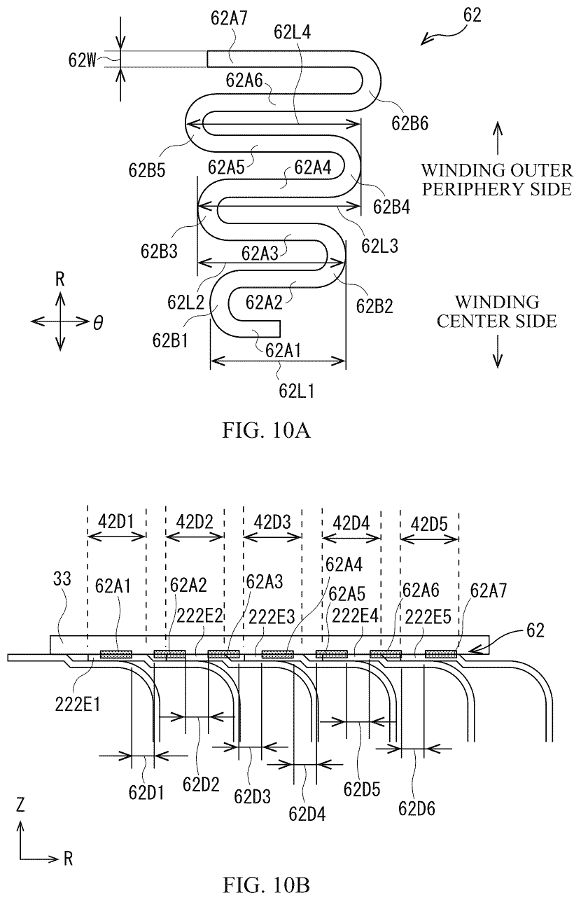

The second joint part 62 may have substantially the same configuration as that of the first joint part 61. FIG. 10A is an enlarged schematic plan view of the second joint part 62. In some embodiments, as illustrated in FIG. 10A, the multiple second joint parts 62 may each have a meander shape in a plan view in a plane orthogonal to the through hole 26. In some embodiments, the second joint parts 62 may each have multiple second linear parts 62A and multiple second turning parts 62B. The second linear parts 62A may be so discretely disposed as to extend along the winding direction (the θ direction) of the electrode wound body 20, and to be adjacent to each other in the radial direction (the R direction) of the electrode wound body 20. The second turning parts 62B may each be a curved part that is so bent as to couple corresponding two of the second linear parts 62A to each other. FIG. 10A illustrates an example in which seven second linear parts 62A1 to 62A7 are provided as the second linear parts 62A, and six second turning parts 62B1 to 62B6 are provided as the second turning parts 62B. However, the number of second linear parts 62A is not limited to a specific number as long as the number is two or more, and the number of second turning parts 62B is not limited to a specific number as long as the number is three or more. Note that in some embodiments, the second linear parts 62A and the second turning parts 62B may each have a constant width 62W.

In some embodiments, in each of the second joint parts 62, a length 62Lb may be longer than a length 62L1. The length 62L1 may be a length in the winding direction (the θ direction) of the electrode wound body 20 from the second turning part 62B1 that is the first one of the second turning parts 62B counted from the winding center of the electrode wound body 20 to the second turning part 62B2 that is the second one of the second turning parts 62B counted from the winding center. The length 62Lb may be a length in the winding direction (the θ direction) of the electrode wound body 20 from a first turning part 62Bb that is a b-th one of the second turning parts 62B, of the corresponding second joint part 62, counted from the winding center to a second turning part 62B(b+1) that is a (b+1)th one of the second turning parts 62B, of the corresponding second joint part 62, counted from the winding center, where the number of second turning parts 62B is represented by “m”, “m” is a natural number, and “b” is a natural number greater than or equal to two and less than “m”. For example, each of lengths 62L2 to 62L4 illustrated in FIG. 10A may be longer than the length 62L1.

In some embodiments, in the configuration example of the second joint part 62 illustrated in FIG. 10A, a length 62L(b+1) may be longer than the length 62Lb. The length 62Lb may be a length in the winding direction (the θ direction) of the electrode wound body 20 from a second turning part 62B(b−1) that is a (b−1)th one of the second turning parts 62B counted from the winding center of the electrode wound body 20 to the b-th second turning part 62Bb counted from the winding center of the electrode wound body 20, and the length 62L(b+1) may be a length in the winding direction (the θ direction) of the electrode wound body 20 from the b-th second turning part 62Bb counted from the winding center of the electrode wound body 20 to the second turning part 62B(b+1) counted from the winding center of the electrode wound body 20, where “b” is a natural number greater than or equal to two and less than or equal to (m−1). For example, in the configuration example of the second joint part 62 illustrated in FIG. 10A, the length 62L2 may be longer than the length 62L1 (62L1<62L2), the length 62L3 may be longer than the length 62L2 (62L2<62L3), and the length 62L4 may be longer than the length 62L3 (62L3<62L4). For example, in the configuration example of the second joint part 62 illustrated in FIG. 10A, a dimension in the winding direction (the θ direction) of the second joint part 62 may gradually increase toward the winding outer periphery side from the winding center side.

In some embodiments, in the configuration example of the second joint part 62 illustrated in FIG. 10A, a ratio 62L(b+1)/62Lb of the length 62L(b+1) to the length 62Lb may be substantially equal to a ratio 62L(b+2)/62L(b+1) of a length 62L(b+2) to the length 62L(b+1). The length 62L(b+2) may be a length in the winding direction (the θ direction) from the (b+1)th second turning part 62B(b+1) to a second turning part 62B(b+2) that is a (b+2)th one of the second turning parts 62B counted from the winding center. For example, a ratio (62L2)/(62L1) of the length 62L2 to the length 62L1 may be substantially equal to a ratio (62L3)/(62L2) of the length 62L3 to the length 62L2, and the ratio (62L3)/(62L2) may be substantially equal to a ratio (62L4)/(62L3) of the length 62L4 to the length 62L3. In other words, the following may be satisfied: {(62L2/62L1)}≈{(62L3/62L2)}≈{(62L4/62L3)}.

FIG. 10B is a sectional diagram illustrating a section of the second joint part 62 and the vicinity thereof. The second joint part 62 may be a portion in which the fan-shaped part 33 of the negative electrode current collector plate 25 and the negative electrode edge part 222E of the negative electrode current collector 22A are joined to each other. In some embodiments, as illustrated in FIG. 10B, each of spacings 62D1 to 62D6 in the radial direction (the R direction) of the second linear parts 62A may be shorter than each of lengths 42D1 to 42D5 in the radial direction (the R direction) of parts 222E1 to 222E5, of the negative electrode edge part 222E, that form the lower end face 42. With such a configuration, each of wound parts of the electrode wound body 20 wound around the central axis CL may be joined to the fan-shaped part 33 of the negative electrode current collector plate 25. For example, the negative electrode edge part 222E of the negative electrode current collector 22A and the fan-shaped part 33 of the negative electrode current collector plate 25 may be joined to each other at a larger number of locations, which allows a current to be extracted from the electrode wound body 20 more favorably.

In the secondary battery 1 according to the present example embodiment, for example, upon charging, lithium ions may be extracted from the positive electrode 21, and the extracted lithium ions may be inserted into the negative electrode 22 via the electrolytic solution. In the secondary battery 1, for example, upon discharging, lithium ions may be extracted from the negative electrode 22, and the extracted lithium ions may be inserted into the positive electrode 21 via the electrolytic solution.

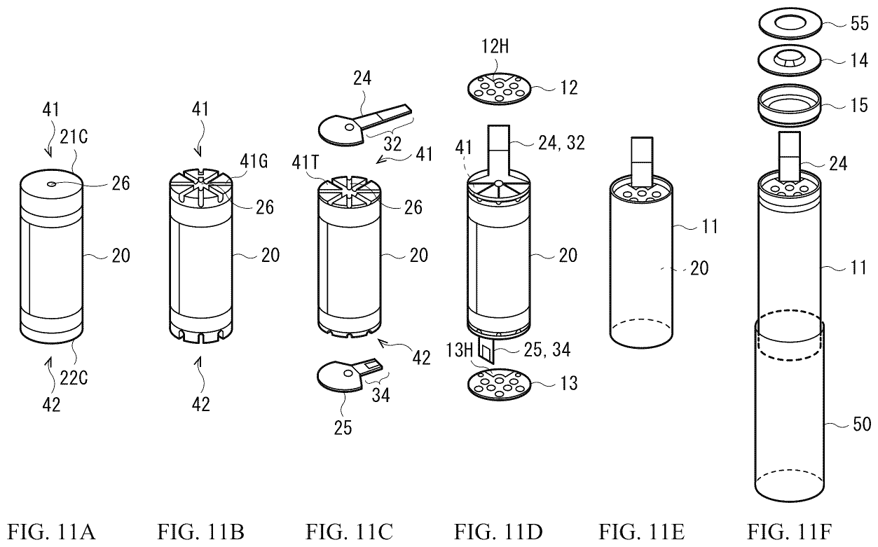

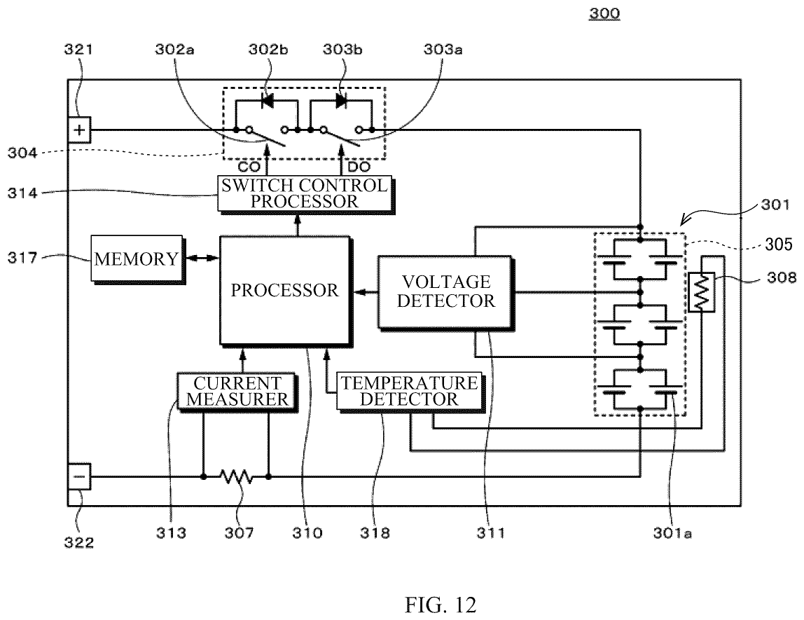

A method of manufacturing the secondary battery 1 will be described with reference to FIGS. 11A to 11F as well as FIGS. 1 to 10B. FIGS. 11A to 11F are each a perspective diagram describing a process of manufacturing the secondary battery 1 illustrated in FIG. 1.

First, the positive electrode current collector 21A may be prepared, and the positive electrode active material layer 21B may be selectively formed on one of or each of the two opposite surfaces of the positive electrode current collector 21A. Thereafter, the insulating layer 100 may be formed on the surface of the positive electrode current collector 21A, along an edge of the positive electrode active material layer 21B. The positive electrode 21 may thus be obtained by the above-described operation. Thereafter, the negative electrode current collector 22A may be prepared, and the negative electrode active material layer 22B may be selectively formed on one of or each of the two opposite surfaces of the negative electrode current collector 22A to thereby form the negative electrode 22 including the negative electrode covered region 221 and the negative electrode exposed region 222. In some embodiments, the positive electrode 21 and the negative electrode 22 may be subjected to a drying process. Thereafter, the positive electrode 21 and the negative electrode 22 may be stacked, with the first separator member 23A and the second separator member 23B on the positive electrode 21 and the negative electrode 22, respectively, to cause the positive electrode exposed region 212 and the first part 222A of the negative electrode exposed region 222 to be on opposite sides to each other in the W direction. The stacked body S20 may thus be fabricated. Thereafter, the stacked body S20 may be so wound in a spiral shape as to form the through hole 26. Upon thus winding the stacked body S20, for example, a circular columnar winding core may be used as a jig, and the stacked body S20 may be wound around the circular columnar winding core. In addition, the fixing tape 46 may be attached to an outermost wind of the stacked body S20 wound in the spiral shape, following which the winding core may be removed. The electrode wound body 20 may thus be obtained as illustrated in FIG. 11A.

Thereafter, a part of the upper end face 41 and a part of the lower end face 42 of the electrode wound body 20 may each be locally bent by pressing an end of, for example, a plate-shaped member having a wedge-shaped section against each of the upper end face 41 and the lower end face 42 perpendicularly, that is, in the Z-axis direction. This process may be referred to as first pressing. As a result, the multiple grooves 41G may be formed on the upper end face 41, and the multiple grooves 42G may be formed on the lower end face 42. Note that the number and arrangement of the grooves 41G illustrated in FIG. 11B are merely examples, and an embodiment of the present disclosure is not limited thereto. In some embodiments, the number of grooves 41G may be any other number, and the grooves 41G may be arranged in any other way.

Thereafter, substantially equal pressures may be applied to the upper end face 41 and the lower end face 42 substantially perpendicularly from above and below the electrode wound body 20 at substantially the same time. This process may be referred to as second pressing. At this time, for example, a rod-shaped jig may be placed in the through hole 26 in advance. By this operation, as illustrated in FIG. 11C, the positive electrode exposed region 212 may be bent to make a part of the upper end face 41 into a flat surface to thereby form the ungrooved part 41T that is not illustrated in FIG. 1, and the first part 222A of the negative electrode exposed region 222 may be bent to make a part of the lower end face 42 into a flat surface to thereby form the ungrooved part 42T that is not illustrated in FIG. 1. In some embodiments, at this time, the parts, of the positive electrode edge part 212E of the positive electrode exposed region 212 at the upper end face 41, that are adjacent to each other in the radial direction of the electrode wound body 20 may be so bent toward the through hole 26 as to overlap each other. Similarly, in some embodiments, the parts, of the negative electrode edge part 222E of the negative electrode exposed region 222 at the lower end face 42, that are adjacent to each other in the radial direction of the electrode wound body 20 may be so bent toward the through hole 26 as to overlap each other. Thereafter, the fan-shaped part 31 of the positive electrode current collector plate 24 may be joined to the ungrooved part 41T of the upper end face 41 by a method such as laser welding, and the fan-shaped part 33 of the negative electrode current collector plate 25 may be joined to the ungrooved part 42T of the lower end face 42 by a method such as laser welding. The first joint part 61 and the second joint part 62 may thereby be formed.

Thereafter, the insulating tapes 53 and 54 may be attached to respective predetermined locations on the electrode wound body 20. Thereafter, as illustrated in FIG. 11D, the band-shaped part 32 of the positive electrode current collector plate 24 may be bent and passed through a hole 12H of the insulating plate 12. Further, the band-shaped part 34 of the negative electrode current collector plate 25 may be bent and passed through a hole 13H of the insulating plate 13.

Thereafter, the electrode wound body 20 having been assembled in the above-described manner may be placed into the outer package can 11 illustrated in FIG. 11E, following which the bottom part 11B of the outer package can 11 and the negative electrode current collector plate 25 may be welded to each other. Thereafter, the narrow part 11S may be formed in the vicinity of the open end part 11N of the outer package can 11. Further, the electrolytic solution may be injected into the outer package can 11, following which the band-shaped part 32 of the positive electrode current collector plate 24 and the safety valve mechanism 30 may be welded to each other.

Thereafter, as illustrated in FIG. 11F, the outer package can 11 may be sealed with the gasket 15, the safety valve mechanism 30, and the battery cover 14, through the use of the narrow part 11S. Thereafter, the outer package can 11 with the washer 55 attached on the battery cover 14 may be covered with the outer package tube 50, following which the outer package tube 50 may be heated by, for example, applying hot air to the outer package tube 50. The outer package tube 50 may thus be contracted and closely attached to the outer surface of the outer package can 11.

The secondary battery 1 according to the present example embodiment may thus be completed.

As described above, in the secondary battery 1 of the present example embodiment, the one or more first joint parts 61 each have the meander shape in a plan view, and the length 61La is longer than the length 61L1. The length 61L1 is the length in the winding direction (the 0 direction) from the first turning part 61B1 that is the first one of the first turning parts 61B counted from the winding center of the electrode wound body 20 to the first turning part 61B2 that is the second one of the first turning parts 61B counted from the winding center. The length 61La is the length in the winding direction (the θ direction) from the first turning part 61Ba that is the a-th one of the first turning parts 61B, of the corresponding first joint part 61, counted from the winding center to the first turning part 61B(a+1) that is the (a+1)th one of the first turning parts 61B, of the corresponding first joint part 61, counted from the winding center. The configuration in which that the one or more first joint parts 61 each have the meander shape in a plan view and the length 61La is longer than the length 61L1 helps to perform current extraction from the stacked body S20 evenly all the way through from an innermost wind part to an outermost wind part of the electrode wound body 20, which in turn helps to obtain a high output. This also helps to prevent a part of the positive electrode active material layer 21B and a part of the negative electrode active material layer 22B of the stacked body S20 from being used locally frequently, which in turn helps to suppress local performance degradation of the positive electrode active material layer 21B and the negative electrode active material layer 22B. Accordingly, the secondary battery 1 of the present example embodiment helps to achieve a favorable charge and discharge cyclability characteristic.

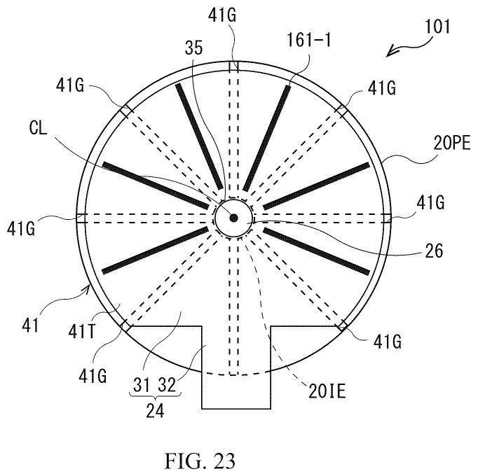

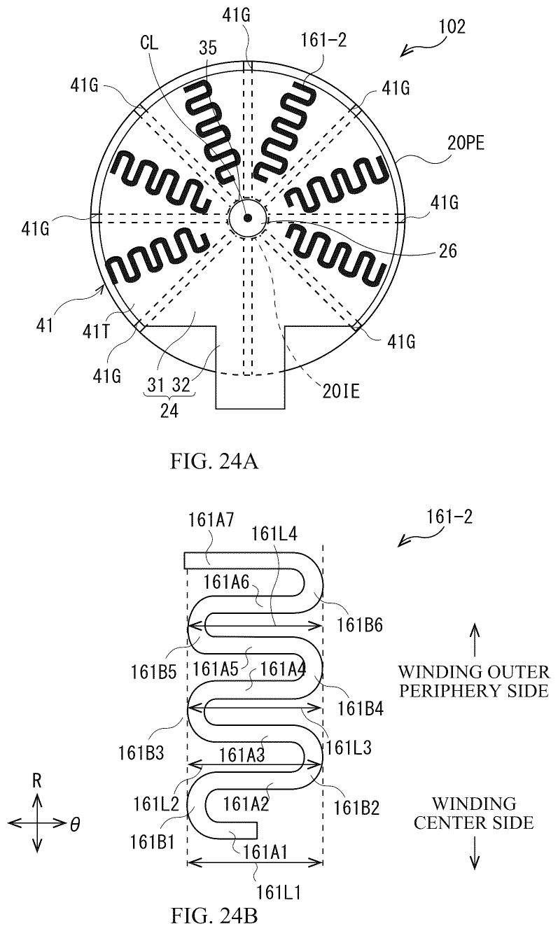

In contrast, a first joint part 161-1 in a secondary battery 101 according to a first comparative example illustrated in FIG. 23 extends linearly in the radial direction (the R direction). In addition, a first joint part 161-2 in a secondary battery 102 according to a second comparative example illustrated in FIGS. 24A and 24B has a meander shape in a plan view; however, a length 161L1 and a length 161La are equal to each other. The length 161L1 is a length in the winding direction (the θ direction) from a first turning part 161B1 that is a first one of the first turning parts 161B counted from the winding center of the electrode wound body 20 to a first turning part 161B2 that is a second one of the first turning parts 161B counted from the winding center of the electrode wound body 20. The length 161La is a length in the winding direction (the θ direction) from a first turning part 161Ba, of the corresponding first joint part 161-2, that is an a-th one of the first turning parts 161B counted from the winding center to a first turning part 161B(a+1), of the corresponding first joint part 161-2, that is an (a+1)th one of the first turning parts 161B counted from the winding center. This can decrease a density of a location in which the positive electrode edge part 212E of the positive electrode current collector 21A and the fan-shaped part 31 of the positive electrode current collector plate 24 are joined to each other, as the electrode wound body 20 comes closer to the winding outer periphery side from the winding center side. This hinders sufficient current extraction from each of the positive electrode active material layer 21B and the negative electrode active material layer 22B in a portion, of a wound part of the electrode wound body 20, that is close to the winding outer periphery side. As a result, a sufficient output may not be obtained. In addition, each of the positive electrode active material layer 21B and the negative electrode active material layer 22B in a portion, of the wound part of the electrode wound body 20, that is close to the winding center side is frequently used, which can accelerate degradation of a charge and discharge cyclability characteristic.

In addition, in the secondary battery 1 of the present example embodiment, the one or more second joint parts 62 may each also have the meander shape in a plan view, and the length 62Lb may be longer than the length 62L1. The length 62L1 may be the length in the winding direction (the θ direction) from the second turning part 62B1 that is the first one of the second turning parts 62B counted from the winding center of the electrode wound body 20 to the second turning part 62B2 that is the second one of the second turning parts 62B counted from the winding center. The length 62Lb may be the length in the winding direction (the θ direction) from the second turning part 62Bb that is the b-th one of the second turning parts 62B, of the corresponding second joint part 62, counted from the winding center to the second turning part 62B(b+1) that is the (b+1)th one of the second turning parts 62B, of the corresponding second joint part 62, counted from the winding center. The configuration in which the one or more second joint parts 62 each have the meander shape in a plan view and the length 62Lb is longer than the length 62L1 helps to perform current extraction from the stacked body S20 evenly to a greater extent all the way through from the innermost wind part to the outermost wind part of the electrode wound body 20. This helps to obtain a higher output, and to achieve a more favorable charge and discharge cyclability characteristic.

In addition, in the secondary battery 1 of the present example embodiment, the dimension in the winding direction (the θ direction) of the first joint part 61 may gradually increase toward the winding outer periphery side from the winding center side, and the dimension in the winding direction (the θ direction) of the second joint part 62 may gradually increase toward the winding outer periphery side from the winding center side. This helps to perform current extraction from the stacked body S20 evenly to an even greater extent all the way through from the innermost wind part to the outermost wind part of the electrode wound body 20. This helps to obtain an even higher output, and to achieve an even more favorable charge and discharge cyclability characteristic.

As described above, the secondary battery 1 according to at least one example embodiment of the present disclosure helps to achieve superior performance.

Non-limiting examples of applications of the secondary battery 1 according to the example embodiment of the present disclosure may be as described below.

FIG. 12 is a block diagram illustrating a circuit configuration example in which the secondary battery 1 according to the example embodiment of the present disclosure is applied to a battery pack 300. The battery pack 300 may include an assembled battery 301, a switcher 304, an outer package body 305, a current detection resistor 307, a temperature detection device 308, and a processor 310. The switcher 304 may include a charge control switch 302a and a discharge control switch 303a. The outer package body 305 may contain the assembled battery 301.

The battery pack 300 may include a positive electrode terminal 321 and a negative electrode terminal 322. Upon charging, the positive electrode terminal 321 and the negative electrode terminal 322 may be respectively coupled to a positive electrode terminal and a negative electrode terminal of a charger to perform charging. Upon use of electronic equipment, the positive electrode terminal 321 and the negative electrode terminal 322 may be respectively coupled to a positive electrode terminal and a negative electrode terminal of the electronic equipment to perform discharging.

The assembled battery 301 may include secondary batteries 301a coupled in series or in parallel. The secondary battery 1 described above is applicable to each of the secondary batteries 301a. FIG. 12 illustrates an example case in which six secondary batteries 301a are coupled in a two parallel coupling and three series coupling (2P3S) configuration; however, the secondary batteries 301a may be coupled in any other manner such as in any n parallel coupling and m series coupling configuration, where each of n and m is an integer.

The switcher 304 may include the charge control switch 302a, a diode 302b, the discharge control switch 303a, and a diode 303b, and may be controlled by the processor 310. The diode 302b may have a polarity that is in a reverse direction with respect to a charge current flowing in a direction from the positive electrode terminal 321 to the assembled battery 301, and that is in a forward direction with respect to a discharge current flowing in a direction from the negative electrode terminal 322 to the assembled battery 301. The diode 303b may have a polarity that is in the forward direction with respect to the charge current and in the reverse direction with respect to the discharge current. In FIG. 12, the switcher 304 may be provided on a positive side; however, in some embodiments, the switcher 304 may be provided on a negative side.

The charge control switch 302a may be so controlled by a charge and discharge control processor that when the battery voltage reaches an overcharge detection voltage, the charge control switch 302a is turned off to thereby prevent the charge current from flowing through a current path of the assembled battery 301. After the charge control switch 302a is turned off, simply discharging may be enabled through the diode 302b. Further, the charge control switch 302a may be so controlled by the processor 310 that when a large current flows upon charging, the charge control switch 302a is turned off to thereby block the charge current flowing through the current path of the assembled battery 301. The discharge control switch 303a may be so controlled by the processor 310 that when the battery voltage reaches an overdischarge detection voltage, the discharge control switch 303a is turned off to thereby prevent the discharge current from flowing through the current path of the assembled battery 301. After the discharge control switch 303a is turned off, simply charging may be enabled through the diode 303b. Further, the discharge control switch 303a may be so controlled by the processor 310 that when a large current flows upon discharging, the discharge control switch 303a is turned off to thereby block the discharge current flowing through the current path of the assembled battery 301.

The temperature detection device 308 may be, for example but not limited to, a thermistor. The temperature detection device 308 may be provided in the vicinity of the assembled battery 301. The temperature detection device 308 may measure a temperature of the assembled battery 301 and may supply data regarding the measured temperature to the processor 310. A voltage detector 311 may measure a voltage of the assembled battery 301 and a voltage of each of the secondary batteries 301a included therein, may perform A/D conversion on the measured voltages, and may supply data regarding the converted voltages to the processor 310. A current measurer 313 may measure a current by the current detection resistor 307 and may supply data regarding the measured current to the processor 310. A switch control processor 314 may control the charge control switch 302a and the discharge control switch 303a of the switcher 304, based on the data regarding the voltages supplied from the voltage detector 311 and the data regarding the current supplied from the current measurer 313.

When a voltage of any of the secondary batteries 301a reaches the overcharge detection voltage or below, or reaches the overdischarge detection voltage or below, or when a large current flows suddenly, the switch control processor 314 may transmit a control signal to the switcher 304 to thereby prevent overcharging and overdischarging, and overcurrent charging and discharging. For example, when the secondary battery is a lithium-ion secondary battery, the overcharge detection voltage may be determined to be, for example, 4.20 V±0.05 V, and the overdischarge detection voltage may be determined to be, for example, 2.4 V±0.1 V.

As the charge control switch 302a and the discharge control switch 303a, for example, semiconductor switches such as metal-oxide-semiconductor field-effect transistors (MOSFETs) may be used. In this case, parasitic diodes of the MOSFETs may serve as the diodes 302b and 303b. When P-channel field-effect transistors (FETs) are used as the charge control switch 302a and the discharge control switch 303a, the switch control processor 314 may supply control signals CO and DO to a gate of the charge control switch 302a and a gate of the discharge control switch 303a, respectively. When the charge control switch 302a and the discharge control switch 303a are of a P-channel type, the charge control switch 302a and the discharge control switch 303a may each be turned on by a gate potential that is lower than a source potential by a predetermined value or more. For example, in normal charging and discharging operations, the control signals CO and DO may be set to a low level to turn on the charge control switch 302a and the discharge control switch 303a.

For example, upon overcharging or overdischarging, the control signals CO and DO may be set to a high level to turn off the charge control switch 302a and the discharge control switch 303a.

A memory 317 may include, for example, a random-access memory (RAM) and a read only memory (ROM). For example, the memory 317 may include a nonvolatile memory such as an erasable programmable read only memory (EPROM). In the memory 317, values including, without limitation, numerical values calculated by the processor 310 and a battery's internal resistance value of each of the secondary batteries 301a in an initial state measured in the manufacturing process stage, may be stored in advance and may be rewritable on an as-needed basis. Further, storing data regarding a full charge capacity of the secondary battery 301a in the memory 317 may allow the processor 310 to calculate, for example, a remaining capacity.

A temperature detector 318 may measure a temperature with use of the temperature detection device 308, may perform charge and discharge control upon abnormal heat generation, and may perform correction in calculating the remaining capacity.

The above-described secondary battery 1 according to the example embodiment of the present disclosure is mountable on, or usable to supply electric power to, for example, any of equipment including, without limitation, electronic equipment, an electric vehicle, an electric aircraft, and a power storage apparatus.

Non-limiting examples of the electronic equipment may include laptop personal computers, smartphones, tablet terminals, personal digital assistants (PDAs) as mobile information terminals, mobile phones, wearable terminals, cordless phone handsets, hand-held video recording and playback devices, digital still cameras, electronic books, electronic dictionaries, music players, radios, headphones, game machines, navigation systems, memory cards, pacemakers, hearing aids, electric tools, electric shavers, refrigerators, air conditioners, televisions, stereos, water heaters, microwave ovens, dishwashers, washing machines, dryers, lighting equipment, toys, medical equipment, robots, road conditioners, traffic lights, and any other electronic equipment to which any embodiment of the present disclosure is applicable.

Non-limiting examples of the electric vehicle may include railway vehicles, golf carts, electric carts, electric automobiles including hybrid electric automobiles, and any other electric vehicle to which any embodiment of the present disclosure is applicable. The secondary battery 1 may be used as a driving power source or an auxiliary power source for any of these electric vehicles. Non-limiting examples of the power storage apparatuses may include a power storage power source for architectural structures including residential houses, or for power generation facilities, and any other power storage apparatus to which any embodiment of the present disclosure is applicable.

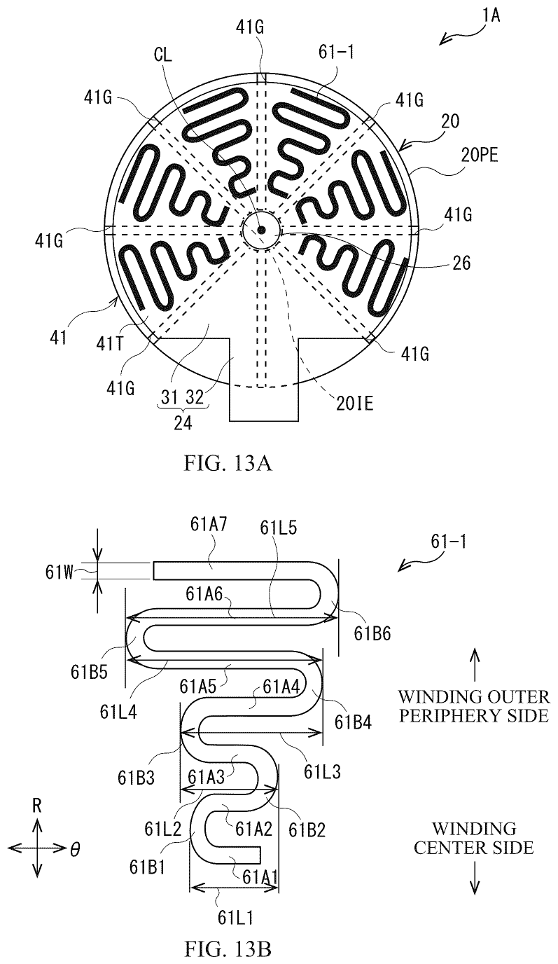

Next, a description is given of a secondary battery 1A according to a first modification example of the secondary battery 1 according to the example embodiment described above. FIG. 13A is a plan diagram illustrating a configuration example of a first joint part 61-1 between the upper end face 41 of the electrode wound body 20 and the positive electrode current collector plate 24 in the secondary battery 1A. FIG. 13B is an enlarged schematic plan view of the first joint part 61-1 illustrated in FIG. 13A. Regarding the first joint part 61 according to the example embodiment described above, an example case is illustrated where the ratio 61L(a+1)/61La of the length 61L(a+1) to the length 61La is substantially equal to the ratio 61L(a+2)/61L(a+1) of the length 61L(a+2) to the length 61L(a+1). The length 61L(a+2) may be the length in the winding direction (the θ direction) from the (a+1)th first turning part 61B(a+1) to the first turning part 61B(a+2) counted from the winding center. In contrast, in the first joint part 61-1 according to the present modification example, the ratio 61L(a+1)/61La may be different from the ratio 61L(a+2)/61L(a+1). For example, the ratio (61L3)/(61L2) of the length 61L3 to the length 61L2 may be greater than the ratio (61L2)/(61L1) of the length 61L2 to the length 61L1. Note that in the secondary battery 1A, the second joint part 62 may also have a configuration similar to that of the first joint part 61-1.

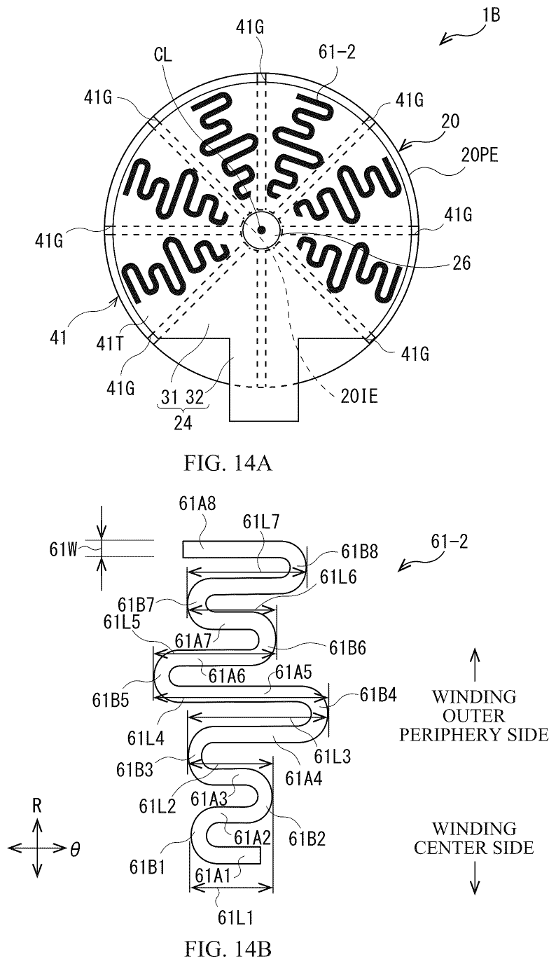

Next, a description is given of a secondary battery 1B according to a second modification example of the secondary battery 1 according to the example embodiment described above. FIG. 14A is a plan diagram illustrating a configuration example of a first joint part 61-2 between the upper end face 41 of the electrode wound body 20 and the positive electrode current collector plate 24 in the secondary battery 1B. FIG. 14B is an enlarged schematic plan view of the first joint part 61-2 illustrated in FIG. 14A. In the first joint part 61 according to the example embodiment described above, the dimension in the winding direction (the θ direction) of the first joint part 61 may gradually increase toward the winding outer periphery side from the winding center side. In contrast, the first joint part 61-2 may include a portion where the length 61La is longer than the length 61L(a+1). Note, however, that the length 61L1 may be the shortest. For example, in the configuration example of the first joint part 61-2, the following may be satisfied: 61L1<61L6<61L2<61L7<61L5<61L3<61L4. Note that in the secondary battery 1B, the second joint part 62 may also have a configuration similar to that of the first joint part 61-2.

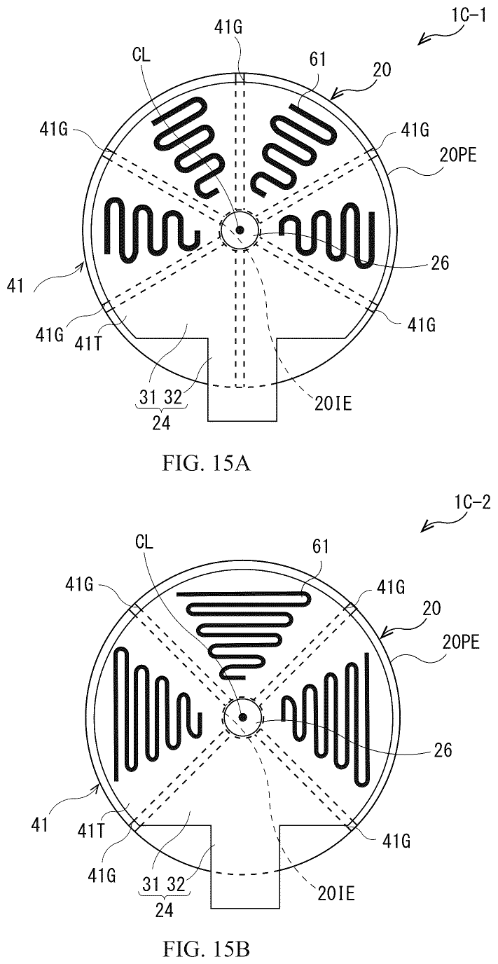

Next, a description is given of secondary batteries 1C-1 and 1C-2 according to a third modification example of the secondary battery 1 according to the example embodiment described above. FIG. 15A is a plan diagram illustrating a configuration example of the first joint part 61 between the upper end face 41 of the electrode wound body 20 and the positive electrode current collector plate 24 in the secondary battery 1C-1 according to a first example of the third modification example. FIG. 15B is a plan diagram illustrating a configuration example of the first joint part 61 between the upper end face 41 of the electrode wound body 20 and the positive electrode current collector plate 24 in the secondary battery 1C-2 according to a second example of the third modification example. In the first joint part 61 according to the example embodiment described above, the six first joint parts 61 may be provided; however, the secondary battery 1C-1 may be provided with four first joint parts 61, and the secondary battery 1C-2 may be provided with three first joint parts 61. Note that the secondary batteries 1C-1 and 1C-2 may each have a configuration of the second joint parts 62 similar to that of the first joint parts 61.

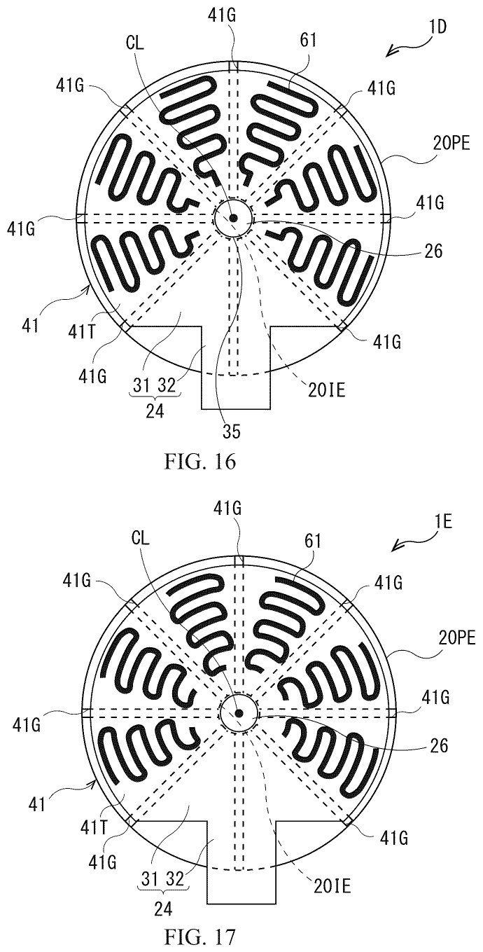

Next, a description is given of a secondary battery 1D according to a fourth modification example of the secondary battery 1 according to the example embodiment described above. FIG. 16 is a plan diagram illustrating a configuration example of the first joint part 61 between the upper end face 41 of the electrode wound body 20 and the positive electrode current collector plate 24 in the secondary battery 1D according to the fourth modification example. The secondary battery 1D according to the fourth modification example may be provided with, for example, a part extending in the radial direction at an end part, of the first joint part 61, on the winding center side. This helps to increase a location in which the upper end face 41 and the positive electrode current collector plate 24 are joined to each other even in a narrow region in the vicinity of the opening 35 provided at the middle of the fan-shaped part 31 of the positive electrode current collector plate 24. Note that in the secondary battery 1D, the second joint part 62 may also have a configuration similar to that of the first joint part 61.

Next, a description is given of a secondary battery 1E according to a fifth modification example of the secondary battery 1 according to the example embodiment described above. FIG. 17 is a plan diagram illustrating a configuration example of the first joint part 61 between the upper end face 41 of the electrode wound body 20 and the positive electrode current collector plate 24 in the secondary battery 1E according to the fifth modification example. In the secondary battery 1E according to the fifth modification example, the first linear part 61A of the first joint part 61 may extend not linearly, but may extend in a curve along the winding direction. Note that in the secondary battery 1E, the second joint part 62 may also have a configuration similar to that of the first joint part 61.

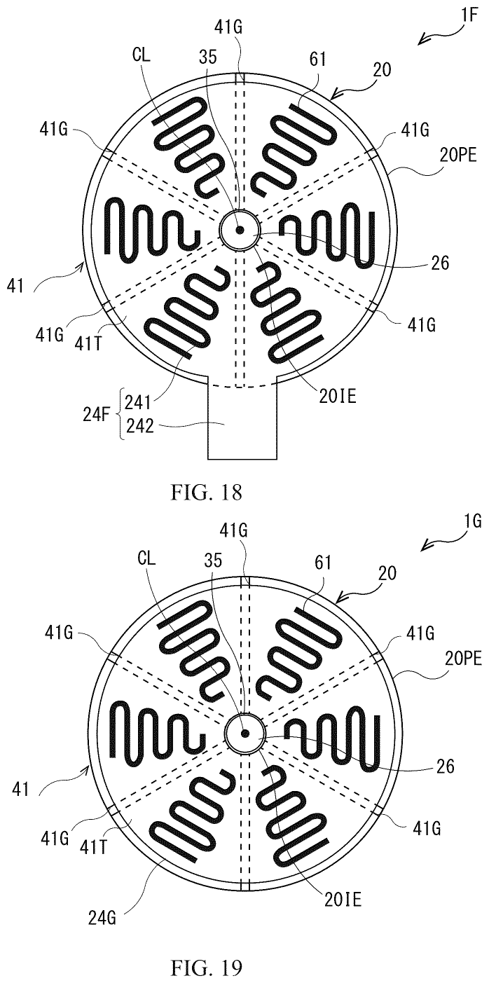

Next, a description is given of a secondary battery 1F according to a sixth modification example of the secondary battery 1 according to the example embodiment described above. FIG. 18 is a plan diagram illustrating a configuration example of the first joint part 61 between the upper end face 41 of the electrode wound body 20 and the positive electrode current collector plate 24 in the secondary battery 1F according to the sixth modification example. In the secondary battery 1F according to the sixth modification example, a positive electrode current collector plate 24F may be used instead of the positive electrode current collector plate 24. The positive electrode current collector plate 24F may include a circular plate part 241 in place of the fan-shaped part 31, and a band-shaped part 242 in place of the band-shaped part 32. The circular plate part 241 of the positive electrode current collector plate 24F may have a plan shape corresponding to a plan shape of the upper end face 41. This helps, in the secondary battery 1F, all the ungrooved parts 41T to be joined to the circular plate part 241 of the positive electrode current collector plate 24F by the respective first joint parts 61. Except for the above-described points, the secondary battery 1F may have a configuration substantially the same as the configuration of the secondary battery 1C-1 according to the first example of the third modification example illustrated in FIG. 15A. Allowing the secondary battery 1F to have such a configuration helps to obtain a higher output than the secondary battery 1C-1. Note that in the secondary battery 1F, the second joint part 62 may also have a configuration similar to that of the first joint part 61.

In addition, as in a secondary battery 1G according to a seventh modification example illustrated in FIG. 19, a positive electrode current collector plate 24G including only a circular plate part and including no band-shaped part may be used. The circular plate part may have a plan shape corresponding to the plan shape of the upper end face 41. Note that the positive electrode current collector plate 24G may have the opening 35. This helps, in the secondary battery 1G also, all the ungrooved parts 41T to be joined to the positive electrode current collector plate 24G by the respective first joint parts 61. Note that in the secondary battery 1G, the second joint part 62 may also have a configuration similar to that of the first joint part 61.

In an embodiment of the present disclosure, as in a secondary battery 1H according to an eighth modification example illustrated in FIG. 20, a positive electrode current collector plate 24H may also be used. The positive electrode current collector plate 24H may include only a circular plate part and may include neither a band-shaped part nor the opening 35. The circular plate part may have a plan shape corresponding to the plan shape of the upper end face 41. This helps, in the secondary battery 1H also, all the ungrooved parts 41T to be joined to the positive electrode current collector plate 24H by the respective first joint parts 61. Note that in the secondary battery 1H, the second joint part 62 may also have a configuration similar to that of the first joint part 61.

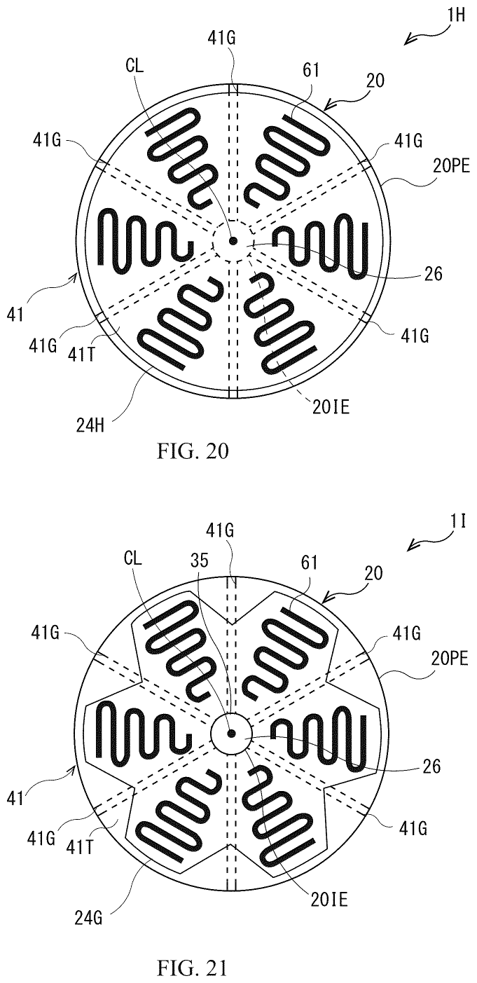

In the present disclosure, as in a secondary battery 1I according to a ninth modification example illustrated in FIG. 21, a positive electrode current collector plate 241 having a shape other than a circular shape may also be used. Note that in the secondary battery 1I, the second joint part 62 may also have a configuration similar to that of the first joint part 61.

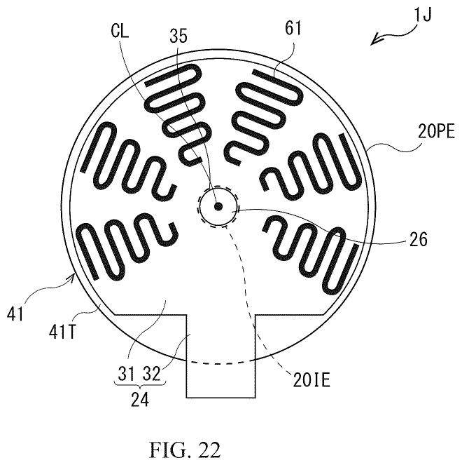

In the present disclosure, as in a secondary battery 1J according to a tenth modification example illustrated in FIG. 22, the upper end face 41 of the electrode wound body 20 may be provided with one ungrooved part 41T and provided with no groove 41G. Note that in the secondary battery 1J, the second joint part 62 may also have a configuration similar to that of the first joint part 61. For example, the lower end face 42 of the electrode wound body 20 may be provided with one ungrooved part 42T and provided with no groove 42G.

Although the present disclosure has been described hereinabove with reference to some example embodiments and modification examples, a configuration of any embodiment of the present disclosure is not limited to the configurations described in relation to the example embodiments and modification examples, and is therefore modifiable in a variety of ways. For example, in the foregoing example embodiment, the description has been given of the case where the electrode reactant is lithium; however, the electrode reactant is not particularly limited. In some embodiments, the electrode reactant may be another alkali metal such as sodium or potassium, as described above. In some embodiments, the electrode reactant may be an alkaline earth metal such as beryllium, magnesium, or calcium, as described above. In some embodiments, the electrode reactant may be another light metal such as aluminum.

In the secondary battery of an example embodiment of the present disclosure, each of a length of the first linear part in the first joint part and a length of the second linear part in the second joint part is not particularly limited. In some embodiments, when the multiple first joint parts are provided, respective shapes and respective thicknesses thereof may be uniform in all of the multiple first joint parts, or the shapes and the thicknesses of one or more of the first joint parts may be different from the shapes and the thicknesses of other first joint parts. The same may apply to the second joint parts when the multiple second joint parts are provided.

In some embodiments, when the multiple first joint parts are provided, the numbers of first turning parts in the respective first joint parts may be different from each other. The same may apply to the second joint parts when the multiple second joint parts are provided.

According to a secondary battery of an example embodiment of the present disclosure, one or more first joint parts each have a predetermined meander shape in a plan view. This helps to perform current extraction from a stacked body evenly all the way through from an innermost wind part to an outermost wind part of an electrode wound body, which in turn helps to obtain a high output.

The effects described herein are mere examples, and effects of an embodiment of the present disclosure are therefore not limited to those described herein. Accordingly, an embodiment of the present disclosure may achieve any other effect.

Furthermore, the present disclosure encompasses any possible combination of some or all of the various embodiments and the modification examples described herein and incorporated herein. It is possible to achieve at least the following configurations from the above-described example embodiments of the present disclosure.

(1) A secondary battery including:
an electrode wound body including a stacked body and having a through hole, the stacked body including a first electrode, a second electrode, and a separator and being wound along a longitudinal direction of the stacked body, the through hole extending through the electrode wound body in a width direction orthogonal to the longitudinal direction; and
a first electrode current collector plate and a second electrode current collector plate that are opposed to each other with the electrode wound body interposed between the first electrode current collector plate and the second electrode current collector plate in the width direction, in which
the electrode wound body includes a first end face and a second end face, the first end face facing the first electrode current collector plate in the width direction, the second end face facing the second electrode current collector plate in the width direction,
the first electrode current collector plate and the first end face are joined to each other by one or more first joint parts,
the one or more first joint parts each have a meander shape in a plan view in a plane orthogonal to the through hole, the meander shape including multiple first linear parts and multiple first turning parts, the first linear parts being adjacent to each other in a radial direction of the electrode wound body, the first turning parts coupling the first linear parts to each other, and
in each of the one or more first joint parts, a length in a winding direction of the electrode wound body from an a-th one of the first turning parts counted from a winding center of the electrode wound body to an (a+1)th one of the first turning parts counted from the winding center is longer than a length in the winding direction from a first one of the first turning parts, of corresponding one of the first joint parts, counted from the winding center to a second one of the first turning parts, of the corresponding one of the first joint parts, counted from the winding center, where a number of the first turning parts is represented by “n”, “n” is a natural number, and “a” is a natural number greater than or equal to two and less than “n”.
   (2) The secondary battery according to (1), in which
in each of the one or more first joint parts, a second length is longer than a first length,
the first length being a length in the winding direction from an (a−1)th one of the first turning parts counted from the winding center to an a-th one of the first turning parts counted from the winding center, where “a” is a natural number greater than or equal to two and less than or equal to (n−1),
the second length being a length in the winding direction from the a-th first turning part to an (a+1)th one of the first turning parts counted from the winding center.
   (3) The secondary battery according to (2), in which
a ratio of the second length to the first length is substantially equal to a ratio of a third length to the second length, the third length being a length in the winding direction from the (a+1)th first turning part to an (a+2)th one of the first turning parts counted from the winding center.
   (4) The secondary battery according to (1), in which
the first electrode includes a first electrode current collector and a first electrode active material layer, the first electrode active material layer covering a part of the first electrode current collector,
the first electrode includes a first electrode covered region and a first electrode exposed region, the first electrode covered region being a region in which the first electrode current collector is covered with the first electrode active material layer, the first electrode exposed region being adjacent to the first electrode covered region in the width direction and being a region in which the first electrode current collector is exposed without being covered with the first electrode active material layer, the first electrode exposed region being joined to the first electrode current collector plate,
the first end face includes parts, of an edge part of the first electrode exposed region, that are bent in a wound state, and
a spacing in the radial direction of the first linear parts is shorter than a length in the radial direction of each of the parts, of the edge part of the first electrode exposed region, that form the first end face.
   (5) The secondary battery according to (4), in which
the first end face has one or more first grooves and a first ungrooved part, the one or more first grooves each extending in the radial direction, the first ungrooved part lying closer to the first electrode current collector plate than the one or more first grooves, and
each of the one or more first joint parts is a portion in which a part of the first ungrooved part and a part of the first electrode current collector plate are joined to each other.
   (6) The secondary battery according to (1), in which
the one or more first joint parts include multiple first joint parts, and
the multiple first joint parts are spaced away from each other.
   (7) The secondary battery according to (1), in which the one or more first joint parts are three or more in number.
   (8) The secondary battery according to (1), in which
the second electrode current collector plate and the second end face are joined to each other by one or more second joint parts,
the one or more second joint parts each have a meander shape in a plan view in a plane orthogonal to the through hole, the meander shape including multiple second linear parts and multiple second turning parts, the second linear parts being adjacent to each other in the radial direction, the second turning parts coupling the second linear parts to each other, and
in each of the one or more second joint parts, a length in the winding direction from a b-th one of the second turning parts counted from the winding center to a (b+1)th one of the second turning parts counted from the winding center is longer than a length in the winding direction from a first one of the second turning parts, of corresponding one of the second joint parts, counted from the winding center to a second one of the second turning parts, of the corresponding one of the second joint parts, counted from the winding center, where a number of the second turning parts is represented by “m”, “m” is a natural number, and “b” is a natural number greater than or equal to two and less than “m”.
   (9) The secondary battery according to (8), in which
in each of the one or more second joint parts, a fifth length is longer than a fourth length,
the fourth length being a length in the winding direction from a (b−1)th one of the second turning parts counted from the winding center to a b-th one of the second turning parts counted from the winding center, where “b” is a natural number greater than or equal to two and less than or equal to (m−1),
the fifth length being a length in the winding direction from the b-th second turning part to a (b+1)th one of the second turning parts counted from the winding center.
   (10) The secondary battery according to (9), in which a ratio of the fifth length to the fourth length is substantially equal to a ratio of a sixth length to the fifth length, the sixth length being a length in the winding direction from the (b+1)th second turning part to a (b+2)th one of the second turning parts counted from the winding center.
   (11) The secondary battery according to (8), in which
the second electrode includes a second electrode current collector and a second electrode active material layer, the second electrode active material layer covering a part of the second electrode current collector,
the second electrode includes a second electrode covered region and a second electrode exposed region, the second electrode covered region being a region in which the second electrode current collector is covered with the second electrode active material layer, the second electrode exposed region being adjacent to the second electrode covered region in the width direction and being a region in which the second electrode current collector is exposed without being covered with the second electrode active material layer, the second electrode exposed region being joined to the second electrode current collector plate,
the second end face includes parts, of an edge part of the second electrode exposed region, that are bent in a wound state, and
a spacing in the radial direction of the second linear parts is shorter than a length in the radial direction of each of the parts, of the edge part of the second electrode exposed region, that form the second end face.
   (12) The secondary battery according to (11), in which
the second end face has one or more second grooves and a second ungrooved part, the one or more second grooves each extending in the radial direction, the second ungrooved part lying closer to the second electrode current collector plate than the one or more second grooves, and
each of the one or more second joint parts is a portion in which a part of the second ungrooved part and a part of the second electrode current collector plate are joined to each other.
   (13) The secondary battery according to (8), in which
the one or more second joint parts include multiple second joint parts, and
the multiple second joint parts are spaced away from each other.
   (14) The secondary battery according to (8), in which the one or more second joint parts are three or more in number.
   (15) The secondary battery according to any one of (1) to (14), in which the first electrode includes a positive electrode, and the second electrode includes a negative electrode.
   (16) A battery pack including:
the secondary battery according to any one of (1) to (15);
a processor configured to control the secondary battery; and
an outer package body containing the secondary battery.

According to a secondary battery of at least an embodiment of the present disclosure and a battery pack including the secondary battery of at least an embodiment of the present disclosure, one or more first joint parts each have a meander shape in a plan view, and, in each of the one or more first joint parts, a length in a winding direction of an electrode wound body from an a-th one of multiple first turning parts of corresponding one of the first joint parts counted from a winding center of the electrode wound body to an (a+1)th one of the first turning parts counted from the winding center is longer than a length in the winding direction from a first one of the first turning parts, of the corresponding one of the first joint parts, counted from the winding center to a second one of the first turning parts, of the corresponding one of the first joint parts, counted from the winding center. This helps to perform current extraction from a stacked body evenly all the way through from an innermost wind part to an outermost wind part of the electrode wound body, which in turn helps to obtain a high output.

As described above, the secondary battery according to at least one example embodiment of the present disclosure and the battery pack according to at least an embodiment of the present disclosure each help to achieve superior performance.

Note that effects of an embodiment of the present disclosure are not necessarily limited to the example effects described above and may include any of a series of effects described herein in relation to the example embodiments of the present disclosure.

Although the present disclosure has been described hereinabove in terms of the example embodiment and modification examples, the present disclosure is not limited thereto. It should be appreciated that variations may be made in the described example embodiment and modification examples by those skilled in the art without departing from the scope of the present disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a stacked body and having a through hole, the stacked body including a first electrode, a second electrode, and a separator and being wound along a longitudinal direction of the stacked body, the through hole extending through the electrode wound body in a width direction orthogonal to the longitudinal direction; and
a first electrode current collector plate and a second electrode current collector plate that are opposed to each other with the electrode wound body interposed between the first electrode current collector plate and the second electrode current collector plate in the width direction, wherein
the electrode wound body includes a first end face and a second end face, the first end face facing the first electrode current collector plate in the width direction, the second end face facing the second electrode current collector plate in the width direction,
the first electrode current collector plate and the first end face are joined to each other by one or more first joint parts,
the one or more first joint parts each have a meander shape in a plan view in a plane orthogonal to the through hole, the meander shape including multiple first linear parts and multiple first turning parts, the first linear parts being adjacent to each other in a radial direction of the electrode wound body, the first turning parts coupling the first linear parts to each other, and
in each of the one or more first joint parts, a length in a winding direction of the electrode wound body from an a-th one of the first turning parts counted from a winding center of the electrode wound body to an (a+1)th one of the first turning parts counted from the winding center is longer than a length in the winding direction from a first one of the first turning parts, of corresponding one of the first joint parts, counted from the winding center to a second one of the first turning parts, of the corresponding one of the first joint parts, counted from the winding center, where a number of the first turning parts is represented by “n”, “n” is a natural number, and “a” is a natural number greater than or equal to two and less than “n”.

2. The secondary battery according to claim 1, wherein
in each of the one or more first joint parts, a second length is longer than a first length,
the first length being a length in the winding direction from an (a−1)th one of the first turning parts counted from the winding center to an a-th one of the first turning parts counted from the winding center, where “a” is a natural number greater than or equal to two and less than or equal to (n−1),
the second length being a length in the winding direction from the a-th first turning part to an (a+1)th one of the first turning parts counted from the winding center.

3. The secondary battery according to claim 2, wherein
a ratio of the second length to the first length is substantially equal to a ratio of a third length to the second length, the third length being a length in the winding direction from the (a+1)th first turning part to an (a+2)th one of the first turning parts counted from the winding center.

4. The secondary battery according to claim 1, wherein
the first electrode includes a first electrode current collector and a first electrode active material layer, the first electrode active material layer covering a part of the first electrode current collector,
the first electrode includes a first electrode covered region and a first electrode exposed region, the first electrode covered region being a region in which the first electrode current collector is covered with the first electrode active material layer, the first electrode exposed region being adjacent to the first electrode covered region in the width direction and being a region in which the first electrode current collector is exposed without being covered with the first electrode active material layer, the first electrode exposed region being joined to the first electrode current collector plate,
the first end face includes parts, of an edge part of the first electrode exposed region, that are bent in a wound state, and
a spacing in the radial direction of the first linear parts is shorter than a length in the radial direction of each of the parts, of the edge part of the first electrode exposed region, that form the first end face.

5. The secondary battery according to claim 4, wherein
the first end face has one or more first grooves and a first ungrooved part, the one or more first grooves each extending in the radial direction, the first ungrooved part lying closer to the first electrode current collector plate than the one or more first grooves, and
each of the one or more first joint parts is a portion in which a part of the first ungrooved part and a part of the first electrode current collector plate are joined to each other.

6. The secondary battery according to claim 1, wherein
the one or more first joint parts comprise multiple first joint parts, and
the multiple first joint parts are spaced away from each other.

7. The secondary battery according to claim 1, wherein the one or more first joint parts are three or more in number.

8. The secondary battery according to claim 1, wherein
the second electrode current collector plate and the second end face are joined to each other by one or more second joint parts,
the one or more second joint parts each have a meander shape in a plan view in a plane orthogonal to the through hole, the meander shape including multiple second linear parts and multiple second turning parts, the second linear parts being adjacent to each other in the radial direction, the second turning parts coupling the second linear parts to each other, and
in each of the one or more second joint parts, a length in the winding direction from a b-th one of the second turning parts counted from the winding center to a (b+1)th one of the second turning parts counted from the winding center is longer than a length in the winding direction from a first one of the second turning parts, of corresponding one of the second joint parts, counted from the winding center to a second one of the second turning parts, of the corresponding one of the second joint parts, counted from the winding center, where a number of the second turning parts is represented by “m”, “m” is a natural number, and “b” is a natural number greater than or equal to two and less than “m”.

9. The secondary battery according to claim 8, wherein
in each of the one or more second joint parts, a fifth length is longer than a fourth length,
the fourth length being a length in the winding direction from a (b−1)th one of the second turning parts counted from the winding center to a b-th one of the second turning parts counted from the winding center, where “b” is a natural number greater than or equal to two and less than or equal to (m−1),
the fifth length being a length in the winding direction from the b-th second turning part to a (b+1)th one of the second turning parts counted from the winding center.

10. The secondary battery according to claim 9, wherein a ratio of the fifth length to the fourth length is substantially equal to a ratio of a sixth length to the fifth length, the sixth length being a length in the winding direction from the (b+1)th second turning part to a (b+2)th one of the second turning parts counted from the winding center.

11. The secondary battery according to claim 8, wherein
the second electrode includes a second electrode current collector and a second electrode active material layer, the second electrode active material layer covering a part of the second electrode current collector,
the second electrode includes a second electrode covered region and a second electrode exposed region, the second electrode covered region being a region in which the second electrode current collector is covered with the second electrode active material layer, the second electrode exposed region being adjacent to the second electrode covered region in the width direction and being a region in which the second electrode current collector is exposed without being covered with the second electrode active material layer, the second electrode exposed region being joined to the second electrode current collector plate,
the second end face includes parts, of an edge part of the second electrode exposed region, that are bent in a wound state, and
a spacing in the radial direction of the second linear parts is shorter than a length in the radial direction of each of the parts, of the edge part of the second electrode exposed region, that form the second end face.

12. The secondary battery according to claim 11, wherein
the second end face has one or more second grooves and a second ungrooved part, the one or more second grooves each extending in the radial direction, the second ungrooved part lying closer to the second electrode current collector plate than the one or more second grooves, and
each of the one or more second joint parts is a portion in which a part of the second ungrooved part and a part of the second electrode current collector plate are joined to each other.

13. The secondary battery according to claim 8, wherein
the one or more second joint parts comprise multiple second joint parts, and
the multiple second joint parts are spaced away from each other.

14. The secondary battery according to claim 8, wherein the one or more second joint parts are three or more in number.

15. The secondary battery according to claim 1, wherein the first electrode comprises a positive electrode, and the second electrode comprises a negative electrode.

16. A battery pack comprising:
a secondary battery;
a processor configured to control the secondary battery; and
an outer package body containing the secondary battery,
the secondary battery including
an electrode wound body including a stacked body and having a through hole, the stacked body including a first electrode, a second electrode, and a separator and being wound along a longitudinal direction of the stacked body, the through hole extending through the electrode wound body in a width direction orthogonal to the longitudinal direction, and
a first electrode current collector plate and a second electrode current collector plate that are opposed to each other with the electrode wound body interposed between the first electrode current collector plate and the second electrode current collector plate in the width direction, wherein
the electrode wound body includes a first end face and a second end face, the first end face facing the first electrode current collector plate in the width direction, the second end face facing the second electrode current collector plate in the width direction,
the first electrode current collector plate and the first end face are joined to each other by one or more first joint parts,
the one or more first joint parts each have a meander shape in a plan view in a plane orthogonal to the through hole, the meander shape including multiple first linear parts and multiple first turning parts, the first linear parts being adjacent to each other in a radial direction of the electrode wound body, the first turning parts coupling the first linear parts to each other, and
in each of the one or more first joint parts, a length in a winding direction of the electrode wound body from an a-th one of the first turning parts counted from a winding center of the electrode wound body to an (a+1)th one of the first turning parts counted from the winding center is longer than a length in the winding direction from a first one of the first turning parts, of corresponding one of the first joint parts, counted from the winding center to a second one of the first turning parts, of the corresponding one of the first joint parts, counted from the winding center, where a number of the first turning parts is represented by “n”, “n” is a natural number, and “a” is a natural number greater than or equal to two and less than “n”.
